(19) United States
(12) Patent Application Publication
(10) Pub. No.: US 2025/0391153 A1
(43) Pub. Date: Dec. 25, 2025

(54) DEVICE AND METHOD FOR CONVERSION IMAGE GENERATED FROM TARGET IMAGE

(71) Applicant: Samsung Electronics Co., Ltd., Suwon-si (KR)

(72) Inventors: Hyeoncheon JO, Suwon-si (KR); Minju KIM, Suwon-si (KR); Hyeongseok KIM, Suwon-si (KR); Jaehyun PARK, Suwon-si (KR); Gajin SONG, Suwon-si (KR); Hoseon SHIN, Suwon-si (KR)

(21) Appl. No.: 19/086,689

(22) Filed: Mar. 21, 2025

Related U.S. Application Data
(63) Continuation of application No. PCT/KR2025/002207, filed on Feb. 14, 2025.

(30) Foreign Application Priority Data
Jun. 21, 2024 (KR) 10-2024-0081086
Jul. 16, 2024 (KR) 10-2024-0093578

(51) Int. Cl. G06V 10/764; G06F 3/14; G06T 3/40; G06T 11/60

(52) U.S. Cl. CPC G06V 10/764; G06F 3/14; G06T 3/40; G06T 11/60; G06V 2201/07

(57) ABSTRACT

An electronic device may include: a display; a processor(s) comprising processing circuitry; and a memory storing instructions, wherein the instructions, when executed by the processor(s) collectively and/or individually, may cause the electronic device to: detect a plurality of candidate objects from a plurality of images; determine a first classification result for the plurality of candidate objects based on a user input for a first display condition; determine a second classification result for the plurality of candidate objects based on a user input for a second display condition; generate a first conversion image corresponding to the first display condition by applying the first classification result to a target image; generate a second conversion image corresponding to the second display condition by applying the second classification result to the target image; display the first conversion image while the electronic device satisfies the first display condition; and display the second conversion image while the electronic device satisfies the second display condition.

### CROSS-REFERENCE TO RELATED APPLICATIONS

This application is a continuation of International Application No. PCT/KR2025/002207 designating the United States, filed on Feb. 14, 2024, in the Korean Intellectual Property Receiving Office and claiming priority to Korean Patent Application Nos. 10-2024-0081086 filed on Jun. 21, 2024, and 10-2024-0093578 filed on Jul. 16, 2024, in the Korean Intellectual Property Office, the disclosures of which are all hereby incorporated by reference herein in their entireties.

### BACKGROUND

### Field

Certain example embodiments may relate to a technology for displaying a conversion image generated from a target image.

### Description of Related Art

Electronic devices may provide functions such as stories and collages, which automatically combine media based on individuals' libraries, to enhance the user experience. For example, in a case where a user captures a large number of images with a camera, storing copies of the images in a server (e.g., cloud space) for secure storage of the images may be a way of keeping data safe. To improve the usability of a service, the server may provide the user with a set of images including at least one image based on a criterion that includes at least one of date, place (e.g., location), or person associated with the large number of stored images, thereby providing better usability to the user. The user who has subscribed to the service with the intention of storing their data (e.g., images) securely may receive better usability from the server than expected. The user may thus have a good impression of the service and be encouraged to continue using the service.

The foregoing information may be provided as background art (or related art) for the purpose of enhancing the understanding of this disclosure. None of the foregoing may be claimed as related art (or prior art) with respect to the disclosure or used to determine prior art.

### SUMMARY

According to various example embodiments, an electronic device may include: a display; a processor comprising processing circuitry; and a memory configured to store instructions, wherein the instructions, when executed by the processor, cause the electronic device to: detect a plurality of candidate objects from a plurality of images; determine a first classification result by classifying at least one of the plurality of candidate objects as an object of interest or an object of non-interest, based on a user input for a first display condition for at least one of an image displaying device that is a device for displaying an image, an image displaying area of a display of the image displaying device, or an image displaying time at which the image is displayed; determine a second classification result, by classifying at least one of the plurality of candidate objects as an object of interest or an object of non-interest, based on a user input for a second display condition; generate, from a target image, a first conversion image corresponding to the first display condition by retaining the object of interest of the first classification result and excluding the object of non-interest of the first classification result; generate, from the target image, a second conversion image corresponding to the second display condition by retaining the object of interest of the second classification result and excluding the object of non-interest of the second classification result; display the first conversion image while the electronic device satisfies the first display condition; and display the second conversion image while the electronic device satisfies the second display condition.

According to various example embodiments, a method performed by an electronic device may include: detecting a plurality of candidate objects from a plurality of images; determining a first classification result by classifying at least one of the plurality of candidate objects as an object of interest or an object of non-interest, based on a user input for a first display condition for at least one of an image displaying device that is a device for displaying an image, an image displaying area of a display of the image displaying device, or an image displaying time at which the image is displayed; determining a second classification result by classifying at least one of the plurality of candidate objects as an object of interest or an object of non-interest, based on a user input for a second display condition; generating, from a target image, a first conversion image corresponding to the first display condition by retaining the object of interest of the first classification result and excluding the object of non-interest of the first classification result; generating, from the target image, a second conversion image corresponding to the second display condition by retaining the object of interest of the second classification result and excluding the object of non-interest of the second classification result; displaying the first conversion image while the electronic device satisfies the first display condition; and displaying the second conversion image while the electronic device satisfies the second display condition.

### BRIEF DESCRIPTION OF THE DRAWINGS

FIG. 1 is a block diagram of an example configuration of an electronic device, according to various example embodiments.

FIG. 2A is a view illustrating an unfolded state of an electronic device, according to various example embodiments.

FIG. 2B is a view illustrating a folded state of an electronic device, according to various example embodiments.

FIG. 2C is a perspective view illustrating an example of a fully unfolded state of an electronic device, according to various example embodiments.

FIG. 2D is a perspective view illustrating an example of a partially unfolded intermediate state (or simply an “intermediate state” herein) of an electronic device, according to various example embodiments.

FIGS. 3A, 3B, 3C, and 3D are views illustrating a fully unfolded state, partially unfolded intermediate states, and a fully folded state of an electronic device, according to various example embodiments.

FIG. 4 is a block diagram of an electronic device, according to various example embodiments.

FIG. 5 is a flowchart illustrating an example of a method of generating and displaying, by an electronic device, a conversion image based on a display condition, according to various example embodiments.

FIG. 6 is a diagram illustrating an example of a classification setting interface for determining a classification result by an electronic device, according to various example embodiments.

FIG. 7 is a diagram illustrating an example of an operation of emphasizing, by an electronic device, a specific graphical representation on a classification setting interface, according to various example embodiments.

FIG. 8 is a diagram illustrating an example of an operation of selecting, by an electronic device, a conversion image from a target image based on a classification result, according to various example embodiments.

FIG. 9 is a diagram illustrating an example of an operation of selecting, by an electronic device, a conversion image from a target image based on a classification result, according to various example embodiments.

FIG. 10 is a diagram illustrating an example of an operation of displaying, by an electronic device, conversion images based on display conditions for an image displaying area of a display, according to various example embodiments.

FIG. 11 is a diagram illustrating an example of an operation of displaying, by an electronic device, conversion images based on display conditions for an image displaying time at which an image is displayed, according to various example embodiments.

FIG. 12 is a diagram illustrating an example of an operation of displaying, by an electronic device, conversion images based on display conditions for an image displaying device, according to various example embodiments.

FIG. 13 is a block diagram illustrating an example configuration of an electronic device, according to various example embodiments.

FIG. 14 is a block diagram illustrating an example configuration of an electronic device, according to various example embodiments.

### DETAILED DESCRIPTION

Hereinafter, various embodiments will be described in greater detail with reference to the accompanying drawings. When describing the various embodiments with reference to the accompanying drawings, like reference numerals refer to like elements, and descriptions thereof are not repeated.

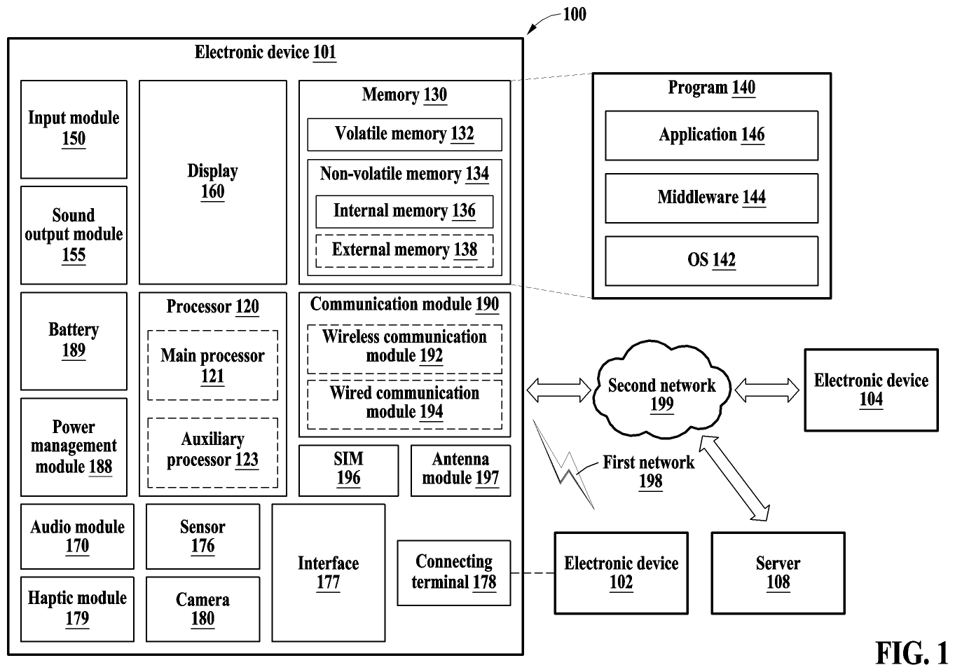

FIG. 1 is a block diagram of an example configuration of an electronic device, according to various embodiments.

FIG. 1 is a block diagram of an electronic device 101 in a network environment 100, according to various embodiments. Referring to FIG. 1, the electronic device 101 in the network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an embodiment, the electronic device 101 may communicate with the electronic device 104 via the server 108.

According to an embodiment, the electronic device 101 may include a processor 120, a memory 130, an input module 150, a sound output module 155, a display 160, an audio module 170, a sensor 176, an interface 177, a connecting terminal 178, a haptic module 179, a camera 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor 176, the camera 180, or the antenna module 197) of the components may be integrated as a single component (e.g., the display 160).

The processor 120 may be implemented as one or more integrated circuits and/or circuitry and may execute various data processing. The processor 120 may include at least one electrical circuit and may perform distributed processing on instructions (or a program 140, data, etc.) stored in the memory 130, individually or collectively. The processor 120 may include a processor set including one or more processing circuits. The processor 120 may include any processing circuitry that is operative to control the performance and operations of one or more components (e.g., the memory 130, the display 160, the camera 180, the communication module 190, and/or the sensor 176) of the electronic device 100. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 120 may execute, for example, software (e.g., the program 140) to control at least one other component (e.g., a hardware or software component) of the electronic device 101 connected, directly or indirectly, to the processor 120, and may perform various data processing or computation. According to an embodiment, as at least a part of data processing or computation, the processor 120 may store a command or data received from another component (e.g., the sensor 176 or the communication module 190) in a volatile memory 132, process the command or data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display 160, the sensor 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera 180 or the communication module 190) that is functionally related to the auxiliary processor 123. According to an embodiment, the auxiliary processor 123 (e.g., an NPU) may include a hardware structure specifically for artificial intelligence (AI) model processing. An AI model may be generated by machine learning. The learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. The receiver may be implemented separately from the speaker or as a part of the speaker.

The display 160 may visually provide information to the outside (e.g., a user) of the electronic device 101. The display 160 may include, for example, a display, a hologram device, or a projector, and control circuitry to control its corresponding one of the display, the hologram device, and the projector. According to an embodiment, the display 160 may include a touch sensor adapted to sense a touch, or a pressure sensor adapted to measure an intensity of a force of the touch.

The audio module 170 may convert sound into an electric signal or vice versa. According to an embodiment, the audio module 170 may acquire the sound via the input module 150 or output the sound via the sound output module 155 or an external electronic device (e.g., the electronic device 102, such as a speaker or headphones) directly or wirelessly connected to the electronic device 101.

The sensor 176 may sense an operational state (e.g., power or temperature) of the electronic device 101 or an environmental state (e.g., a state of a user) external to the electronic device 101 and generate an electric signal or data value corresponding to the sensed state. According to an embodiment, the sensor 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The sensor 176 may also include, for example, an inertial measurement unit (IMU).

The interface 177 may support one or more specified protocols to be used by the electronic device 101 to couple with an external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. The haptic module 179 may include, for example, a motor, a piezoelectric element, or an electric stimulator.

The camera 180 may capture a still image and moving images. According to an embodiment, the camera 180 may include one or more lenses, one or more image sensors, one or more ISPs, and one or more flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more communication circuits. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., an LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4th generation (4G) network, and a next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to some embodiments, another component (e.g., a radio frequency integrated circuit (RFIC)) other than the radiating element may be additionally formed as a part of the antenna module 197.

According to various embodiments, the antenna module 197 may form an mmWave antenna module. According to an embodiment, the mmWave antenna module may include a PCB, an RFIC on a first surface (e.g., a bottom surface) of the PCB or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the components described above may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199.

Each of the external electronic devices (e.g., 102 and 104) and the server 108 may be a device of the same type as or a different type from the electronic device 101. According to an embodiment, all or some of operations to be executed by the electronic device 101 may be executed by one or more of the external electronic devices (e.g., 102 and 104) or the server 108. For example, if the electronic device 101 needs to perform a function or a service automatically, or in response to a request from a user or another device, the electronic device 101, instead of, or in addition to, executing the function or service, may request one or more external electronic devices to perform at least a part of the function or service. The one or more external electronic devices receiving the request may perform the at least part of the function or the service requested, or an additional function or an additional service related to the request and may transfer a result of the performance to the electronic device 101. The electronic device 101 may provide the result, with or without further processing of the result, as at least part of a response to the request.

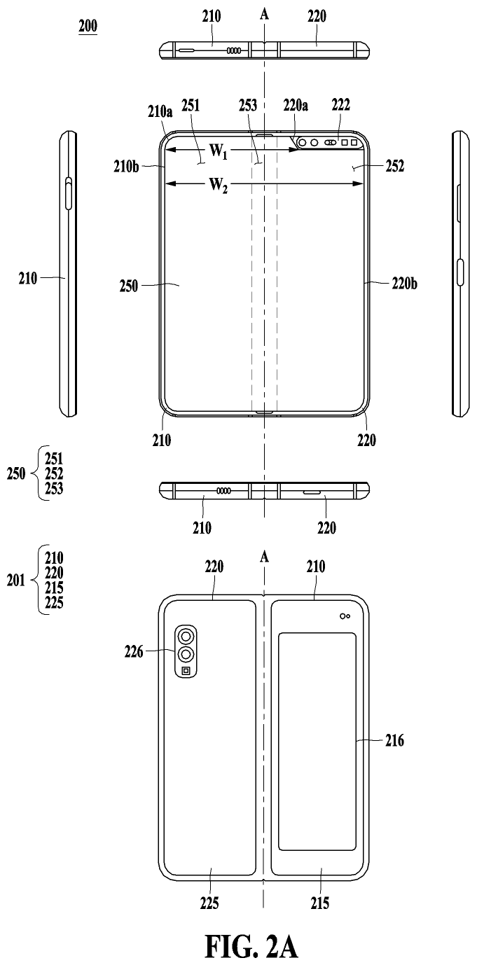

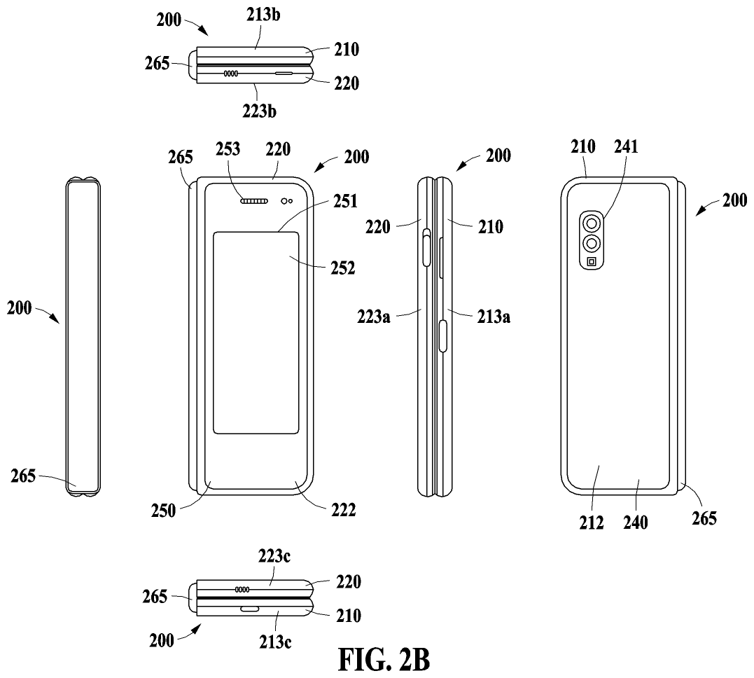

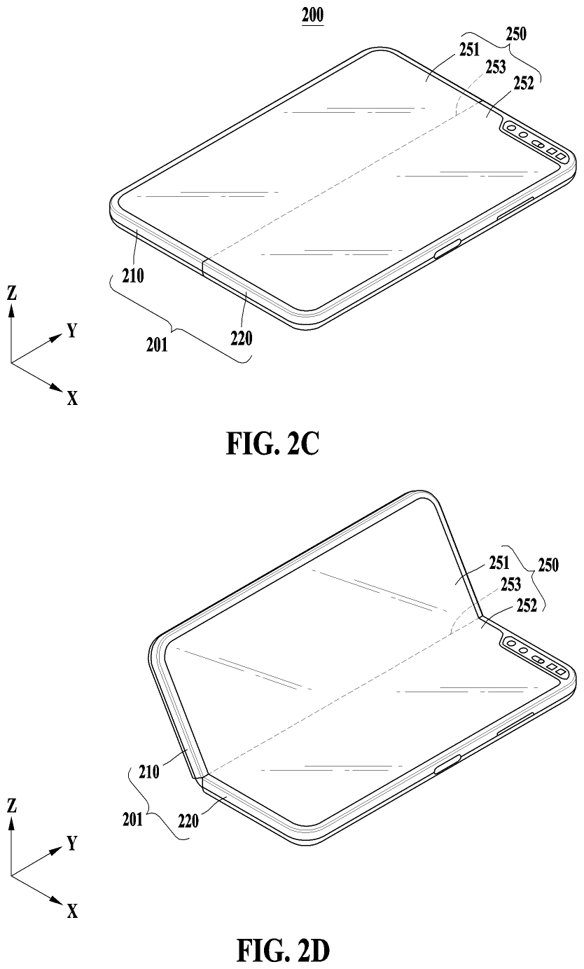

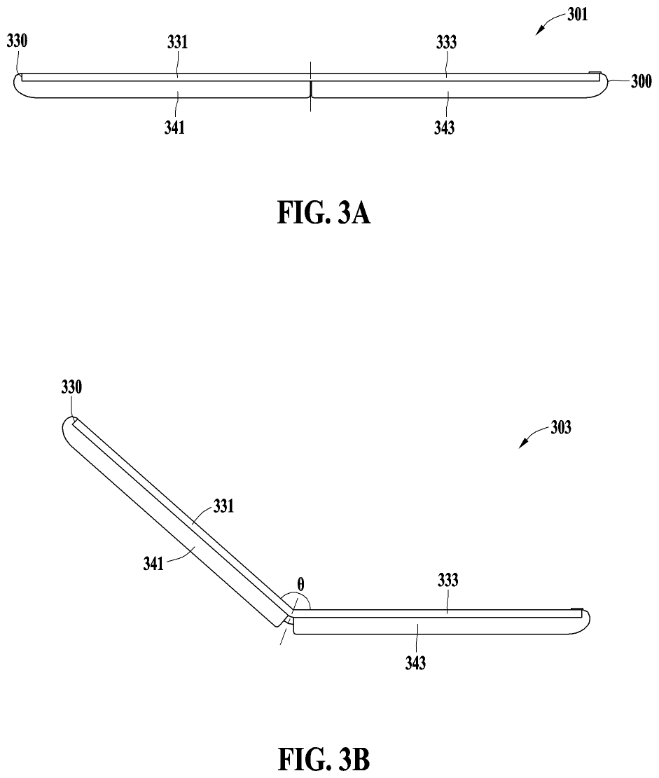

FIG. 2A is a view illustrating an unfolded state of an electronic device 200, according to various embodiments. FIG. 2B is a view illustrating a folded state of the electronic device 200, according to various embodiments. FIG. 2C is a perspective view illustrating an example of a fully unfolded state of the electronic device 200, according to various embodiments. FIG. 2D is a perspective view illustrating an example of a partially unfolded intermediate state (or simply an “intermediate state” herein) of the electronic device 200, according to various embodiments.

The electronic device 200 of FIGS. 2A, 2B, 2C, and 2D may be an example of the electronic device 101 shown in FIG. 1, and may be a foldable or bendable electronic device.

FIGS. 2C and 2D show a spatial coordinate system defined by an X-axis, a Y-axis, and a Z-axis orthogonal to each other. Here, the X-axis may denote a width direction of an electronic device, the Y-axis may denote a length direction of the electronic device, and the Z-axis may denote a height (or thickness) direction of the electronic device. In the following description, a “first direction” may refer to a direction parallel to the Z-axis.

Referring to FIGS. 2A and 2B, in an example embodiment, the electronic device 200 may include a foldable housing 201, and a flexible or foldable display 250 (simply referred to hereinafter as the “display” 250) (e.g., the display 160 of FIG. 1) disposed in a space formed by the foldable housing 201. According to an embodiment, a surface on which the display 250 is disposed (or a surface on which the display 250 is viewed from an outside of the electronic device 200) may be a front surface of the electronic device 200. In addition, a surface opposite the front surface may be a rear surface of the electronic device 200. In addition, a surface surrounding a space between the front surface and the rear surface may be defined as a side surface of the electronic device 200. “Disposed” on as used herein cover directly and indirectly disposed on.

According to various embodiments, the foldable housing 201 may include a first housing structure 210, a second housing structure 220 including a sensor area 222, a first rear cover 215, a second rear cover 225, and a hinge structure 230. Here, the hinge structure 230 may include a hinge cover that covers a foldable portion of the foldable housing 201. The foldable housing 201 of the electronic device 200 is not limited to the shape and coupling shown in FIGS. 2A and 2B but may be implemented in a different shape or a different combination and/or coupling of components. For example, in another embodiment, the first housing structure 210 and the first rear cover 215 may be integrally formed, and the second housing structure 220 and the second rear cover 225 may be integrally formed.

According to various embodiments, the first housing structure 210 may be connected, directly or indirectly, to the hinge structure 230, and may include a first surface facing a first direction and a second surface facing a second direction opposite the first direction. The second housing structure 220 may be connected, directly or indirectly, to the hinge structure 230, and may include a third surface facing a third direction and a fourth surface facing a fourth direction opposite the third direction. The second housing structure 220 may rotate with respect to the first housing structure 210 about the hinge structure 230. A state of the electronic device 200 may be changed to a folded state or an unfolded state.

According to an embodiment, the first surface may face the third surface in a state in which the electronic device 200 is fully folded, and the third direction may be identical to the first direction in a state in which the electronic device 200 is fully unfolded.

According to various embodiments, the first housing structure 210 and the second housing structure 220 may be disposed on both sides of a folding axis A and generally symmetrical with respect to the folding axis A. As described below, an angle or distance between the first housing structure 210 and the second housing structure 220 may vary depending on whether the electronic device 200 is in the unfolded state, the folded state, or a partially unfolded (or partially folded) intermediate state. According to an embodiment, unlike the first housing structure 210, the second housing structure 220 may additionally include the sensor area 222 in which various sensors are arranged but may be mutually symmetrical to the first housing structure 210 in shape in areas excluding the sensor area 222.

According to various embodiments, as shown in FIG. 2A, the first housing structure 210 and the second housing structure 220 may together form a recess for accommodating the display 250. According to an embodiment, due to the sensor area 222, the recess may have at least two different widths in a direction perpendicular to the folding axis A. According to an embodiment, the recess may have a first width w1 between a first portion 210a, parallel to the folding axis A, of the first housing structure 210 and a first portion 220a, formed at an edge of the sensor area 222, of the second housing structure 220. The recess may have a second width w2 formed by a second portion 210b of the first housing structure 210 and a second portion 220b, parallel to the folding axis A while not corresponding to the sensor area 222, of the second housing structure 220. In this case, the second width w2 may be longer than the first width w1. According to an embodiment, the first portion 220a and the second portion 220b of the second housing structure 220 may be at different distances from the folding axis A. The width of the recess is not limited to the illustrated examples. In another embodiment, the recess may have a plurality of widths due to the shape of the sensor area 222 or asymmetrical portions of the first housing structure 210 and the second housing structure 220. According to various embodiments, the sensor area 222 may be formed to have a predetermined (e.g., specified) area adjacent to one corner of the second housing structure 220. However, the arrangement, shape, and size of the sensor area 222 are not limited to the illustrated examples. For example, in another embodiment, the sensor area 222 may be provided at another corner of the second housing structure 220 or in a predetermined area between an upper corner and a lower corner. In an example embodiment, components embedded in the electronic device 200 to perform various functions may be exposed to the front surface of the electronic device 200 through the sensor area 222 or through one or more openings provided in the sensor area 222. In various embodiments, the components may include various types of sensors. The sensors may include, for example, at least one of a front camera, a receiver, or a proximity sensor. According to various embodiments, the sensor area 222 may not be included in the second housing structure 220 or may be formed at a position different from that shown in the drawings.

According to various embodiments, at least a portion of the first housing structure 210 and the second housing structure 220 may be formed of a metal material or a non-metal material having a selected magnitude of rigidity to support the display 250. At least a portion formed of the metal material may provide a ground plane for the electronic device 200, and may be electrically connected, directly or indirectly, to a ground line formed on, directly or indirectly, a PCB disposed inside the foldable housing 201. “Formed on” as used herein covers both formed directly and indirectly on.

According to various embodiments, the first rear cover 215 may be disposed on one side of the folding axis A on the rear surface of the electronic device 200, and may have, for example, a substantially rectangular periphery that may be enclosed by the first housing structure 210. Similarly, the second rear cover 225 may be disposed on another side of the folding axis A on the rear surface of the electronic device 200, and may have a periphery that may be enclosed by the second housing structure 220. “Disposed on” as used herein covers disposed both directly and indirectly on.

According to various embodiments, the first rear cover 215 and the second rear cover 225 may be substantially symmetrical about the folding axis A. However, the first rear cover 215 and the second rear cover 225 are not necessarily mutually symmetrical, and in another embodiment, the electronic device 200 may include the first rear cover 215 and the second rear cover 225 having various shapes. In another embodiment, the first rear cover 215 may be formed integrally with the first housing structure 210, and the second rear cover 225 may be formed integrally with the second housing structure 220.

According to various embodiments, the first rear cover 215, the second rear cover 225, the first housing structure 210, and the second housing structure 220 may form a space in which various components (e.g., a PCB or a battery) of the electronic device 200 are to be arranged. According to an embodiment, one or more components may be disposed or visually exposed on the rear surface of the electronic device 200. For example, at least a portion of a sub-display may be visually exposed through a first rear area 216 of the first rear cover 215. In another embodiment, one or more components or sensors may be visually exposed through a second rear area 226 of the second rear cover 225. In various embodiments, the sensors may include a proximity sensor and/or a rear camera.

According to various embodiments, a front camera exposed to the front surface of the electronic device 200 through one or more openings provided in the sensor area 222, or a rear camera exposed through the second rear area 226 of the second rear cover 225 may include one or more lenses, an image sensor, and/or an ISP. A flash may include, for example, a light-emitting diode (LED) or a xenon lamp. In various embodiments, two or more lenses (e.g., infrared camera, wide-angle, and telephoto lenses) and image sensors may be disposed on one surface of the electronic device 200.

Referring to FIG. 2B, the hinge cover may be disposed between the first housing structure 210 and the second housing structure 220 to cover internal components (e.g., the hinge structure 230). According to an embodiment, the hinge structure 230 may be covered by a portion of the first housing structure 210 and a portion of the second housing structure 220, or may be exposed to the outside, depending on the state (e.g., the unfolded state, the intermediate state, or the folded state) of the electronic device 200.

According to an embodiment, when the electronic device 200 is in the unfolded state (e.g., fully unfolded state) as shown in FIG. 2A, the hinge structure 230 may be covered by the first housing structure 210 and the second housing structure 220 not to be exposed. As another example, when the electronic device 200 is in the folded state (e.g., fully folded state), as shown in FIG. 2B, the hinge structure 230 may be exposed to the outside between the first housing structure 210 and the second housing structure 220. As another example, when the first housing structure 210 and the second housing structure 220 are in the intermediate state where the first housing structure 210 and the second housing structure 220 are folded with a certain angle therebetween, a portion of the hinge structure 230 may be exposed to the outside between the first housing structure 210 and the second housing structure 220. However, an area exposed in this case may be smaller than that in the fully folded state. In an example embodiment, the hinge cover 230 may have a curved surface.

According to various embodiments, the display 250 may be disposed in a space formed by the foldable housing 201. For example, the display 250 may be seated on the recess formed by the foldable housing 201 and may be viewed from the outside through the front surface of the electronic device 200. For example, the display 250 may include most of the front surface of the electronic device 200. Accordingly, the front surface of the electronic device 200 may include the display 250, and a partial area of the first housing structure 210 and a partial area of the second housing structure 220, which are adjacent to the display 250. In addition, the rear surface of the electronic device 200 may include the first rear cover 215, a partial area of the first housing structure 210 adjacent to the first rear cover 215, the second rear cover 225, and a partial area of the second housing structure 220 adjacent to the second rear cover 225.

According to various embodiments, the display 250 may refer to a display having at least a partial area that is deformable into a flat surface or a curved surface. According to an embodiment, the display 250 may include a folding area 253, a first area 251 disposed on one side of the folding area 253 (e.g., on the left side of the folding area 253 shown in FIG. 2A), and a second area 252 disposed on the other side of the folding area 253 (e.g., on the right side of the folding area 253 shown in FIG. 2A).

However, such an area division of the display 250 shown in FIG. 2A is merely an example, and the display 250 may be divided into a plurality of areas (e.g., four or more areas, or two areas) depending on a structure or function thereof. For example, in the embodiment shown in FIG. 2A, the display 250 may be divided into areas based on the folding area 253 extending in parallel to the folding axis A. In another embodiment, the display 250 may be divided into areas based on another folding axis (e.g., a folding axis parallel to a width direction of the electronic device).

According to various embodiments of the disclosure, the display 250 may be coupled to or disposed adjacent to a touch panel in which a touch detection circuit and a pressure sensor configured to measure an intensity (or pressure) of a touch are provided. For example, the display 250 is an example of the touch panel, and may be coupled to or disposed adjacent to the touch panel that detects an electromagnetic resonance (EMR)-type stylus pen.

According to various embodiments, the first area 251 and the second area 252 may be generally symmetrical about the folding area 253. However, unlike the first area 251, the second area 252 may include a notch that is cut depending on the presence of the sensor area 222, but may be symmetrical to the first area 251 in other areas. For example, the first area 251 and the second area 252 may include a mutually symmetrical portion and a mutually asymmetrical portion.

According to various embodiments, an edge thickness of the first area 251 and the second area 252 may be different from an edge thickness of the folding area 253. The edge thickness of the folding area 253 may be less than that of the first area 251 and the second area 252. The first area 251 and the second area 252 may be asymmetrical in terms of thickness when the first area 251 and the second area 252 are cross-sectionally viewed. For example, an edge of the first area 251 may be formed to have a first radius of curvature, and an edge of the second area 252 may be formed to have a second radius of curvature different from the first radius of curvature. In another example, the first area 251 and the second area 252 may be symmetrical in terms of thickness when the first area 251 and the second area 252 are cross-sectionally viewed.

Hereinafter, operations of the first housing structure 210 and the second housing structure 220 depending on the state (e.g., the folded state, the unfolded state, or the intermediate state) of the electronic device 200, and areas of the display 250 are described.

According to various embodiments, when the electronic device 200 is in the unfolded state (e.g., FIG. 2A), the first housing structure 210 and the second housing structure 220 may be arranged to face the same direction while forming an angle of 180 degrees. The surface of the first area 251 of the display 250 and the surface of the second area 252 thereof may face the same direction (e.g., the front direction of the electronic device) while forming 180 degrees. The folding area 253 may form the same plane in conjunction with the first area 251 and the second area 252.

According to various embodiments, when the electronic device 200 is in the folded state (e.g., FIG. 2B), the first housing structure 210 and the second housing structure 220 may be arranged to face each other. The surface of the first area 251 of the display 250 and the surface of the second area 252 thereof may face each other while forming a narrow angle (e.g., between 0 degrees and 10 degrees). At least a portion of the folding area 253 may form a curved surface having a predetermined curvature.

According to various embodiments, when the electronic device 200 is in the intermediate state, the first housing structure 210 and the second housing structure 220 may be arranged with a certain angle therebetween. The surface of the first area 251 of the display 250 and the surface of the second area 252 thereof may form an angle greater than that in the folded state and smaller than that in the unfolded state. At least a portion of the folding area 253 may include a curved surface having a predetermined curvature, and the curvature may be smaller than that in the folded state.

FIG. 2C shows a fully unfolded state of the electronic device 200, and FIG. 2D shows a partially unfolded intermediate state of the electronic device 200. As described above, the state of the electronic device 200 may be changed to the folded state or the unfolded state. According to an embodiment, when viewed in a direction of a folding axis (e.g., the folding axis A of FIG. 2A), the electronic device 200 may be folded in two types, e.g., an “in-folding” type in which the front surface of the electronic device 200 is folded to form an acute angle, and an “out-folding” type in which the front surface of the electronic device 200 is folded to form an obtuse angle. For example, in the state in which the electronic device 200 is folded in the in-folding type, the first surface of the first housing structure 210 may face the third surface of the second housing structure 220. In the fully unfolded state, the first surface of the first housing structure 210 and the third surface of the second housing structure 220 may face the same direction (e.g., a direction parallel to the Z-axis).

In addition, for example, when the electronic device 200 is folded in the out-folding type, the second surface of the first housing structure 210 may face the fourth surface of the second housing structure 220.

In addition, although not shown, the electronic device 200 may include a plurality of hinge axes (e.g., two parallel hinge axes including the folding axis A of FIG. 2A and another axis parallel to the folding axis A). In this case, the electronic device 200 may also be folded in a “multi-folding” type in which the in-folding type and the out-folding type are combined.

The in-folding type may refer to a state in which the display 250 is not exposed to the outside in the fully folded state. The out-folding type may refer to a state in which the display 250 is exposed (e.g., visible) to the outside in the fully folded state. FIG. 2D shows an intermediate state in which the electronic device 200 is partially unfolded while being in-folded.

Although the state in which the electronic device 200 is folded in the in-folding type is primarily described below for ease of description, it is to be noted that the description may be similarly applied in the state in which the electronic device 200 is folded in the out-folding type.

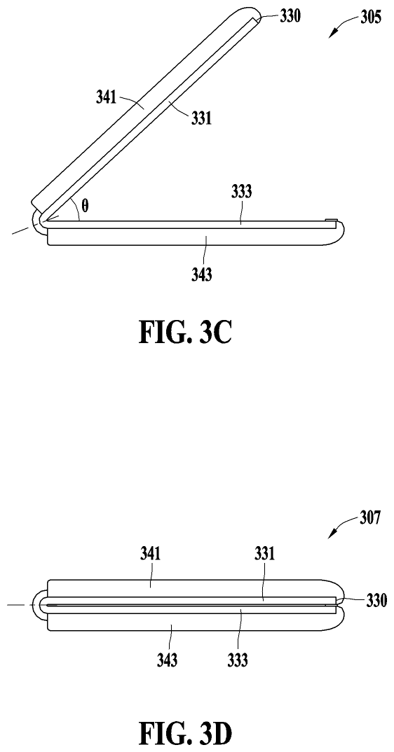

FIGS. 3A, 3B, 3C, and 3D are views illustrating a fully unfolded state, partially unfolded intermediate states, and a fully folded state of an electronic device, according to various embodiments.

Referring to FIGS. 3A, 3B, 3C, and 3D, an electronic device 300 (e.g., the electronic device 101 of FIG. 1 or the electronic device 200 of FIGS. 2A through 2D) may include a foldable display 330 (e.g., the display 160 of FIG. 1 or the display 250 of FIGS. 2A through 2D), a first housing 341, and a second housing 343.

A state 301 may be a fully unfolded state or an unfolded state of the electronic device 300.

From the state 301, the electronic device 300 may be folded. For example, the electronic device 300 may be folded as the first housing 341 and/or the second housing 343 are folded.

According to an embodiment, as the electronic device 300 is folded, the first area 331 and the second area 333 of the foldable display 330 may form an angle θ based on a folding axis, as shown in a state 303 and a state 305. When the angle θ is within a predetermined range, the state 303 and the state 305 may be referred to as a “partially unfolded intermediate state,” and the angle θ formed by the first area 331 and the second area 333 may be referred to as a “folding angle”.

According to an embodiment, the folding angle in the partially unfolded intermediate state 303 may be about 135 degrees, and the folding angle in the partially unfolded intermediate state 305 may be about 45 degrees.

A state 307 may be a fully folded state of the electronic device 300.

In the examples shown in FIGS. 3A, 3B, 3C, and 3D, the electronic device 300 may be folded such that the first area 331 and the second area 333 may face each other. In other words, the screen may be folded inward. This folding type may also be referred to as the in-folding type. Alternatively, the electronic device 300 may be implemented such that the first area 331 and the second area 333 may be folded in opposite directions. In other words, the screen may be implemented to be folded outward.

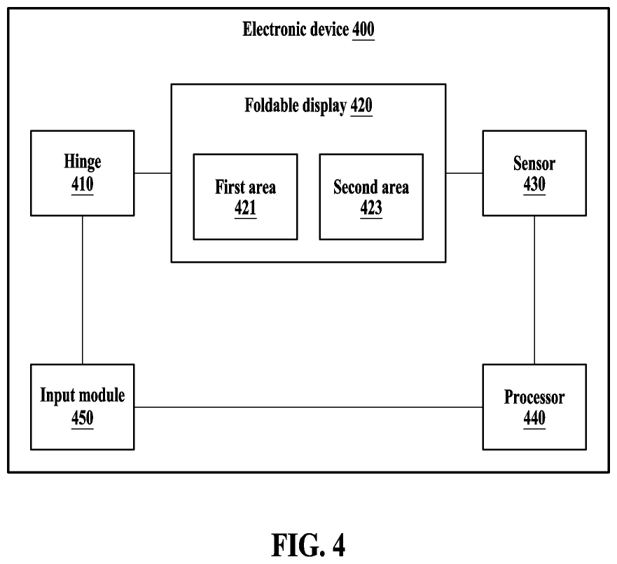

FIG. 4 is a block diagram of an electronic device, according to various embodiments.

An electronic device 400 (e.g., the electronic device 101 of FIG. 1, the electronic device 200 of FIGS. 2A through 2D, or the electronic device 300 of FIGS. 3A through 3D) according to an embodiment may include a hinge 410 configured to allow the electronic device 400 to be folded or unfolded, a foldable display 420 (e.g., the display 160 of FIG. 1 or the display 250 of FIGS. 2A through 2D) disposed on at least one side of the electronic device 400 such that the electronic device 400 may be folded or unfolded about the hinge 410, a sensor 430 (e.g., the sensor 176 of FIG. 1) configured to detect a state (e.g., an unfolded state, a partially unfolded intermediate state, or a folded state) of the electronic device 400, a processor 440 (e.g., including processing circuitry) configured to control a screen to be displayed through the foldable display 420 according to the state of the electronic device 400, and an input module 450 (e.g., the input module 150 of FIG. 1).

The processor 440 may include a variety of processing circuitry, and may determine the state of the electronic device 400 to be one of the unfolded state corresponding to an unfolded state of the foldable display 420, the partially unfolded intermediate state corresponding to a state in which the foldable display 420 forms a folding angle within a predefined folding angle range, and the folded state corresponding to a folded state of the foldable display 420.

According to an embodiment, the hinge 410 may allow the electronic device 400 to be folded or unfolded, and as the electronic device 400 is folded or unfolded about the hinge 410, the foldable display 420 may also be folded or unfolded. The foldable display 420 may be disposed on at least one side of the electronic device 400, and may include a first area 421 (e.g., the first area 251 of FIGS. 2A through 2D) disposed on one side of the hinge 410 and a second area 423 (e.g., the second area 252 of FIGS. 2A through 2D) disposed on the other side of the hinge 410.

According to an embodiment, the hinge 410 may include a first hinge and a second hinge, and the foldable display 420 may include the first area 421 disposed on one side of the first hinge, the second area 423 disposed on the other side of the first hinge and disposed on one side of the second hinge, and a third area (not shown) disposed on the other side of the second hinge.

According to an embodiment, the sensor 430 (e.g., the sensor 176 of FIG. 1) may include at least one sensor, and may detect a folding angle (e.g., the folding angle θ of FIGS. 3A, 3B, 3C, and 3D) of the electronic device 400. The sensor 430 according to an embodiment may be a Hall sensor, an acceleration sensor, and/or a gyro sensor (e.g., a gyroscope). For example, the acceleration sensor and/or the gyro sensor may detect the folding angle of the electronic device 400. The sensor 430 according to an embodiment may be disposed inside the hinge 410 to detect the folding angle by detecting the number of gear rotations. The sensor 430 according to an embodiment may detect not only the folding angle but also the timepoint at which folding starts and the angle at which folding stops.

For example, the sensor 430 may be a Hall sensor. The Hall sensor may be a transducer that generates an electrical signal (e.g., a voltage) in response to a magnetic field. The Hall sensor may generate an electrical signal of a relatively high intensity when the magnetic field is strong, and generate an electrical signal of a relatively low intensity when the magnetic field is weak. For example, the Hall sensor may be positioned in a first housing structure (e.g., the first housing structure 210 of FIGS. 2A through 2D), and an element (e.g., a magnetic body) that generates a magnetic field may be positioned in a second housing structure (e.g., the second housing structure 220 of FIGS. 2A through 2D). Depending on the implementation, the Hall sensor may be positioned in the second housing structure, and the magnetic body may be positioned in the first housing structure. When the electronic device 400 changes from the fully unfolded state to the folded state, the Hall sensor may be close to the magnetic body and detect the folded state of the foldable display 420 in response to the magnetic field of the magnetic body. The Hall sensor may also detect the folding angle through the intensity of the electrical signal generated in response to the magnetic field.

The Hall sensor is merely an example of the sensor 430, and the sensor 430 is not limited to the Hall sensor. According to an embodiment, the folding angle of the electronic device 400 may be detected using a magnetic (or geomagnetic) sensor and a Hall sensor. For example, the magnetic (or geomagnetic) sensor and the Hall sensor may include a transmitter configured to generate a magnetic field of a specific frequency and a receiver configured to receive the magnetic field generated by the transmitter, and may detect the folding angle based on a change in the state of the electronic device 400. For example, the magnetic (or geomagnetic) sensor may measure bearings using the magnetic field and magnetic force lines, and the Hall sensor may detect a change in the state of the electronic device 400 by detecting the intensity of the magnetic field and detect the folding angle (e.g., the folding angle θ of FIGS. 3A, 3B, 3C, and 3D) according to the detected change in the state.

Although it is described above that the sensor 430 detects the folded state of the foldable display 420 and detects the folding angle, the processor 440 may detect the folded state of the foldable display 420 based on a sensing result acquired by the sensor 430 and calculate the folding angle, according to an embodiment. For example, the processor 440 may receive an electrical signal based on magnetic field detection from the Hall sensor. The processor 440 may detect the folded state of the foldable display 420 by receiving the electrical signal from the Hall sensor. The processor 440 may also calculate the folding angle of the foldable display 420 based on the intensity of the electrical signal received from the Hall sensor.

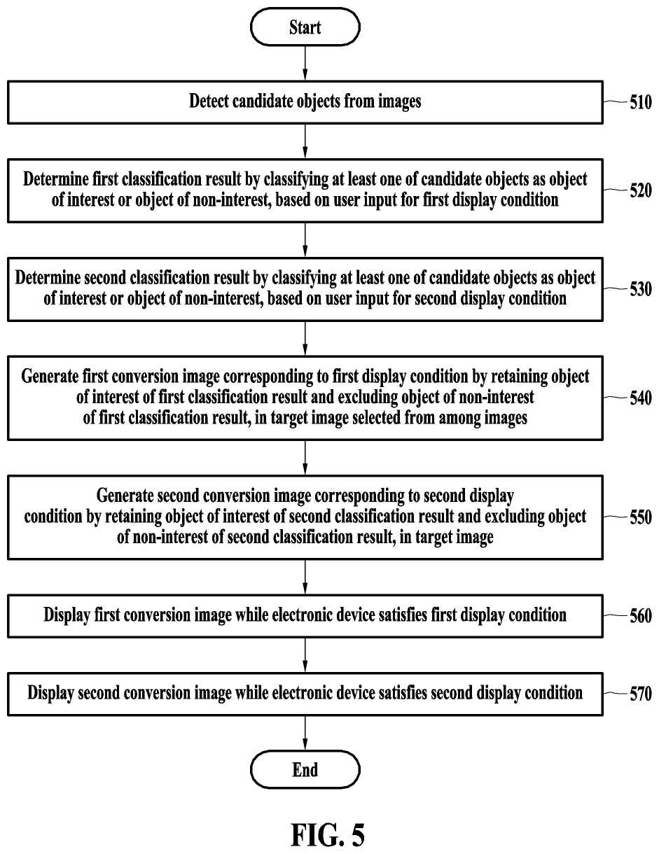

FIG. 5 is a flowchart illustrating an example of a method of generating and displaying, by an electronic device, a conversion image based on a display condition, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may generate and display a conversion image based on a display condition.

According to an embodiment, the display condition (e.g., a first display condition or a second display condition) may refer to a condition associated with an environment and/or a situation in which an image is displayed. The display condition may include a condition for at least one of an image displaying device that is a device on which an image is displayed, an image displaying area in a display of the image displaying device, or an image displaying time at which an image is displayed.

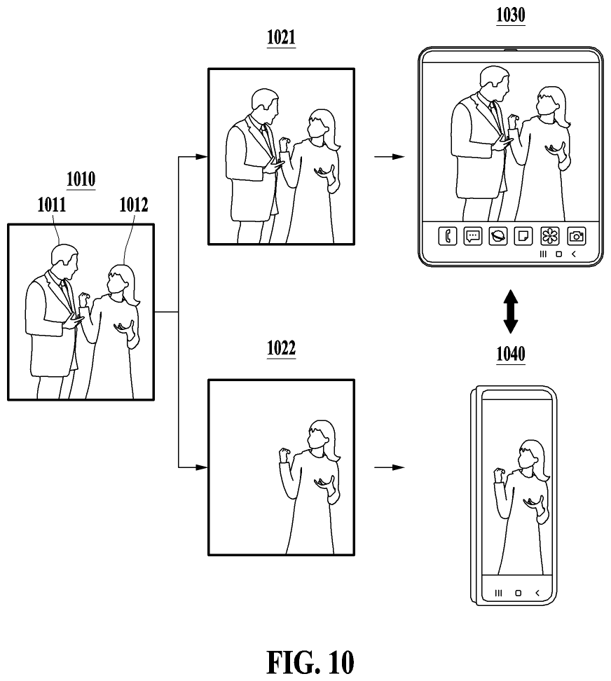

For example, in a case where a display of the electronic device includes a first area and a second area, the first display condition may include displaying an image in the first area, and the second display condition may include displaying an image in the second area. Examples of the display condition for the image displaying area are described in more detail below with reference to FIG. 10.

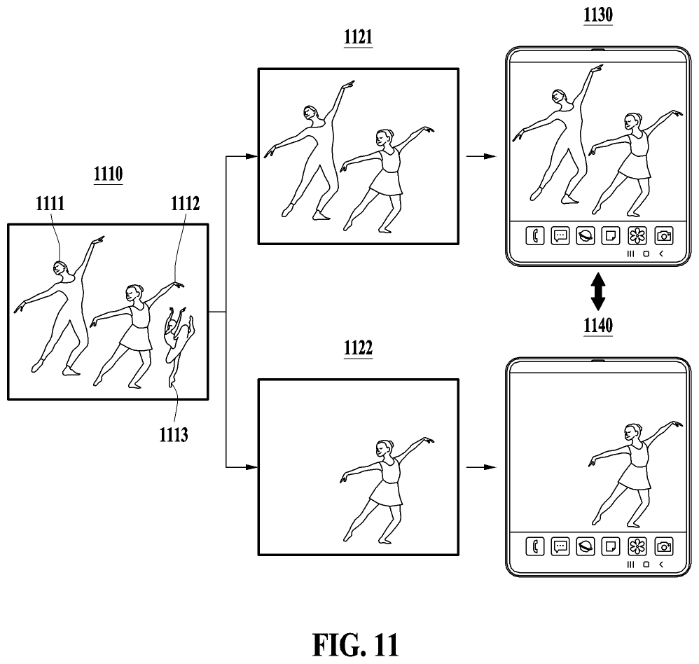

For example, the display condition may include the condition for the image displaying time at which an image is displayed. The first display condition may relate to the image displaying time being included in a first time range, and the second display condition may relate to the image displaying time being included in a second time range. Examples of the display condition for the image displaying time are described in more detail below with reference to FIG. 11.

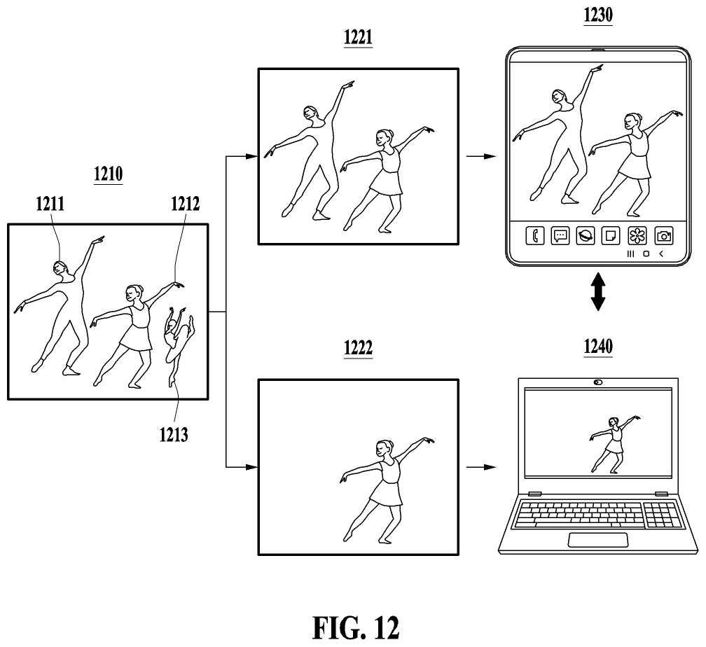

For example, the display condition may include the condition for the image displaying device on which an image is displayed. The first display condition may include displaying an image on the electronic device, and the second display condition may include displaying an image on another electronic device. Examples of the display condition for the image displaying device are described in more detail below with reference to FIG. 12.

Hereinafter, operations performed by the electronic device to generate and display a conversion image according to the display condition are described.

At operation 510, the electronic device may detect a plurality of candidate objects from a plurality of images.

According to an embodiment, the plurality of images may include images accessible by the electronic device. For example, the images accessible by the electronic device may include images stored in a memory (e.g., the memory 130 of FIG. 1) of the electronic device or an external device (e.g., the electronic device 102 of FIG. 1, the electronic device 104 of FIG. 1, or the server 108 of FIG. 1) connected to the electronic device.

According to an embodiment, the plurality of images may be specified based on a user input. For example, the plurality of images may be specified by the user based on at least one of an application, a directory (e.g., folder) in which images are stored, or a device storing images.

The electronic device may detect a candidate object from the plurality of images. According to an embodiment, the electronic device may detect a specific type of object as the candidate object. For example, the electronic device may detect a human-type object as the candidate object. However, the electronic device according to various embodiments of the present disclosure does not necessarily detect only the human-type object as the candidate object. For example, the electronic device may also detect an animal-type object (e.g., a dog or cat), an object-type object (e.g., a car, food, or furniture), or a nature-type object (e.g., a tree, flower, or mountain) as the candidate object.

The electronic device may attempt to detect a candidate object in each image. The electronic device may fail to detect a candidate object in one image or may succeed in detecting one candidate object or two or more candidate objects in one image.

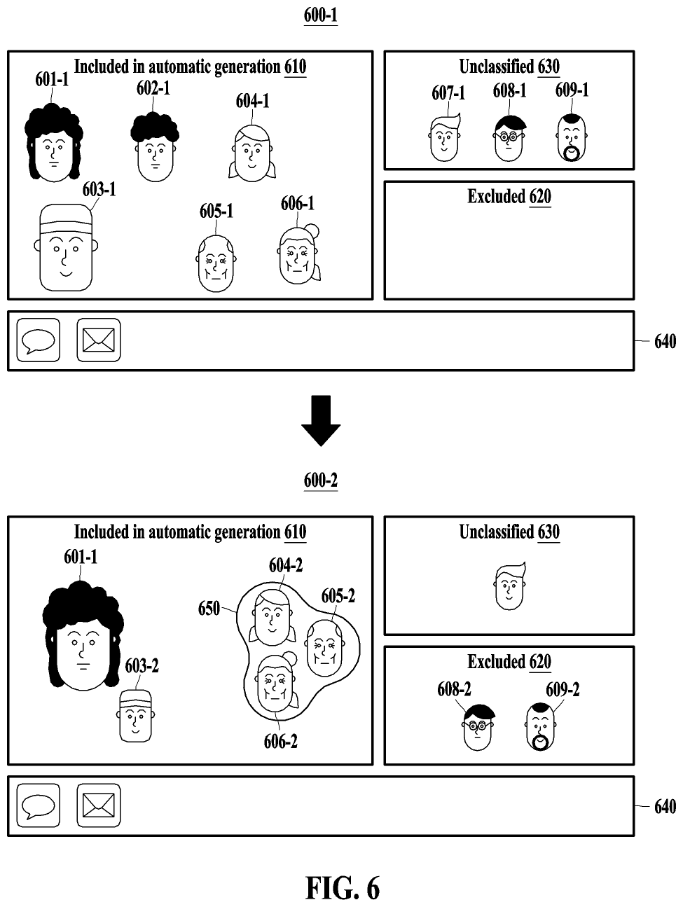

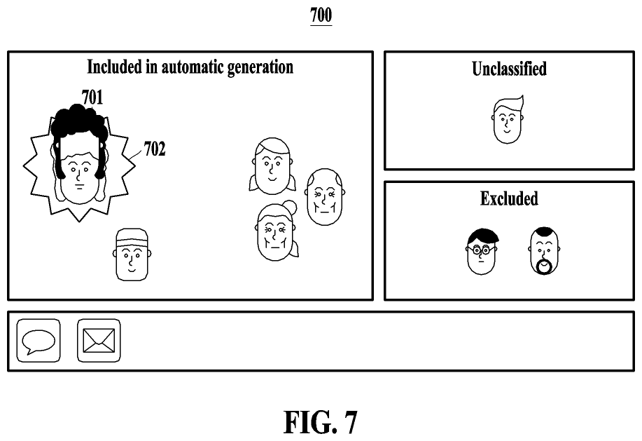

According to an embodiment, the electronic device may determine an identity between the detected candidate objects. For example, in a case where the electronic device identifies an object detected in a first image and an object detected in a second image as the same object, the electronic device may map (e.g., label or tag) the same object identifier to the objects detected in the first image and the second image. As described in more detail below with reference to FIGS. 6 and 7, the electronic device may determine an attribute (e.g., size or brightness) of a graphical representation corresponding to a specific object based on the number of images in which the specific object (e.g., an object having a specific object identifier) is detected among the plurality of images.

At operation 520, the electronic device may determine a first classification result by classifying at least one of the plurality of candidate objects as an object of interest or an object of non-interest based on a user input for the first display condition.

According to an embodiment, the user input for the first display condition may include user input for determining the first classification result for a first conversion image to be displayed when the first display condition is satisfied. As be described below regarding operation 540, the electronic device may generate the first conversion image based on the first classification result. A classification setting interface, which is a user interface (UI) for acquiring a user input for the display condition, is described in more detail below with reference to FIGS. 6 and 7.

According to an embodiment, a classification result (e.g., a first classification result or a second classification result) may include a result of classifying at least one of the plurality of candidate objects as an object of interest or an object of non-interest. For example, the object of interest may be an object that is set to appear in an image when a corresponding display condition is satisfied. For example, the object of non-interest may be an object that is set to not appear in an image (e.g., to be excluded from the image) when a corresponding display condition is satisfied.

According to an embodiment, the classification result (e.g., the first classification result or the second classification result) may include a result of classifying the plurality of candidate objects as one of an object of interest, an object of non-interest, or an unclassified object. The unclassified object may be an object that is not classified as one of the object of interest or the object of non-interest, and may be set to appear or not to appear in an image when a corresponding display condition is satisfied.

In various embodiments of the present disclosure, each of the object of interest, the object of non-interest, and the unclassified object may be represented as a class of an object, and determining a specific object as one of the object of interest, the object of non-interest, or the unclassified object may be represented as determining the class of the specific object.

At operation 530, the electronic device may determine the second classification result by classifying at least one of the plurality of candidate objects as an object of interest or an object of non-interest, based on a user input for the second display condition.

Similar or identical to the user input for the first display condition, the user input for the second display condition may include an input for determining the second classification result for a second conversion image to be displayed when the second display condition is satisfied. As described below regarding operation 550, the electronic device may generate the second conversion image based on the second classification result.

According to an embodiment, the first classification result and the second classification result may be determined independently of each other. For example, an object classified as the object of interest in the first classification result may be classified as the object of non-interest or the unclassified object in the second classification result. Conversely, an object classified as the object of interest in the second classification result may be classified as the object of non-interest or the unclassified object in the first classification result. The user may desire to display an image including a specific object under the first display condition and not to display an image including a specific object under the second display condition. For example, the specific object may be a privacy-related object (e.g., lover). The user may generate, as the user input for the first display condition, a user input that classifies the specific object as the object of interest and may generate, as the user input for the second display condition, a user input that classifies the specific object as the object of non-interest.

According to an embodiment, the electronic device may select, as a target image, at least one image including at least one of the object of interest of the first classification result or the object of interest of the second classification result, from among the plurality of images. However, the electronic device does not necessarily select the target image based on the object of interest of the first classification result or the object of interest of the second classification result. For example, the electronic device may also select the target image based on a user input that specifies the at least one image of the plurality of images as the target image.

At operation 540, the electronic device may generate, from the target image selected from the plurality of images, the first conversion image corresponding to the first display condition by retaining the object of interest of the first classification result and excluding the object of non-interest of the first classification result. The first conversion image may refer to an image to be displayed in place of the target image when the first display condition is satisfied.

According to an embodiment, the electronic device may generate a conversion image (e.g., the first conversion image or the second conversion image) by applying image inpainting to the target image. The electronic device may detect, in the target image, an area in which an object of non-interest of a classification result (e.g., the first classification result or the second classification result) appears. The electronic device may acquire an intermediate image in which the area including the object of non-interest of the classification result is removed from the target image. The electronic device may reconstruct the removed area by applying image inpainting to the intermediate image. The electronic device may generate the conversion image by applying, to the intermediate image, an inpainting model for image inpainting. The inpainting model may refer to a model generated and/or trained to generate or provide output data corresponding to the conversion image from input data corresponding to the intermediate image. The inpainting model may include a model based on a machine learning model (e.g., a neural network, a convolutional neural network (CNN), or a generative adversarial network (GAN)).

At operation 550, the electronic device may generate, from the target image, the second conversion image corresponding to the second display condition by retaining the object of interest of the second classification result and excluding the object of non-interest of the second classification result. The target image may be, but is not limited to, an image selected from among the plurality of images, or may be a separate image independent of the plurality of images. The second conversion image may be an image to be displayed in place of the target image when the second display condition is satisfied. The electronic device may generate the second conversion image by applying image inpainting to the target image.

As described above, the first classification result and the second classification result may be independent of each other, and thus an object removed from the first conversion image may be retained in the second conversion image and/or an object retained in the first conversion image may be removed from the second conversion image.

At operation 560, the electronic device may display the first conversion image while the electronic device satisfies the first display condition. The electronic device may display the first conversion image in which the object of interest of the first classification result is retained and the object of non-interest of the first classification result is excluded while the first display condition is satisfied. For example, the electronic device may not display the object of non-interest of the first classification result while the first display condition is satisfied.

At operation 570, the electronic device may display the second conversion image while the electronic device satisfies the second display condition. The electronic device may display the second conversion image in which the object of interest of the second classification result is retained and the object of non-interest of the second classification result is excluded while the second display condition is satisfied. For example, the electronic device may not display the object of non-interest of the second classification result while the second display condition is satisfied.

FIG. 6 is a diagram illustrating an example of a classification setting interface for determining a classification result by an electronic device, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may provide a classification setting interface (e.g., 600-1 or 600-2) for acquiring a user input for determining a classification result corresponding to a display condition.

According to an embodiment, the classification setting interface 600-1 or 600-2 may include an interest object area 610 corresponding to an object of interest, a non-interest object area 620 corresponding to an object of non-interest, and an unclassified object area 630 corresponding to an unclassified object. The classification setting interface 600-1 or 600-2 may include a source area 640 for specifying a plurality of images. The source area 640 may be an area for specifying a plurality of images based on a user input, to which and/or from which at least one of an application, a directory storing images, or a device storing images may be added and/or deleted. For example, as shown in FIG. 6, in response to an icon of a messaging application and an icon of a mail application being added to the source area 640, a plurality of images may be specified as images acquired through the messaging application and images acquired through the mail application.

According to an embodiment, the electronic device may display a plurality of graphical representations respectively corresponding to a plurality of candidate objects, in one of the interest object area 610, the non-interest object area 620, or the unclassified object area 630 of the classification setting interface 600-1 or 600-2.

Referring to FIG. 6, the electronic device may display, on the classification setting interface 600-1, nine graphical representations 601-1, 602-1, 603-1, 604-1, 605-1, 606-1, 607-1, 608-1, and 609-1 respectively corresponding to nine candidate objects. In the classification setting interface 600-1, the graphical representations 601-1, 602-1, 603-1, 604-1, 605-1, and 606-1 may be located in the interest object area 610 and the graphical representations 607-1, 608-1, and 609-1 may be located in the unclassified object area 630.

According to an embodiment, the electronic device may detect an object from an image when the image is acquired by receiving, storing, and/or capturing the image. The electronic device may determine whether there is a candidate object that is identified as the same object as the detected object among previously detected candidate objects. When the candidate object identified as the same object as the detected object among the previously detected candidate objects is present, the electronic device may map an object identifier of the identified candidate object to the detected object, and may change (e.g., increase) a frequency of appearance of the identified candidate object. The frequency of appearance may be determined by the number of images in which the candidate object is detected among the plurality of images.

According to an embodiment, when there is no candidate object identified as the same object as the detected object among the previously detected candidate objects, the electronic device may assign a new object identifier to the detected object that is different from object identifiers of the previously detected candidate objects. The electronic device may map the new object identifier to the detected object and add it as a new candidate object to the classification setting interface 600-1. The electronic device may display a graphical representation corresponding to the new candidate object on the classification setting interface 600-1.

According to an embodiment, the electronic device may initially classify the new candidate object into a determined class (e.g., unclassified object) among an interest object class corresponding to the object of interest, a non-interest object class corresponding to the object of non-interest, and an unclassified object class corresponding to the unclassified object. In various embodiments of the present disclosure, the expression “initially classify” may be construed that the electronic device determines a default class of the new candidate object before detecting a user input for classifying the new candidate object after detecting the new candidate object. The electronic device may display a graphical representation corresponding to the new candidate object, in an area corresponding to the default class of the new candidate object.

However, the electronic device according to various embodiments of the present disclosure does not necessarily initially classify the new candidate object into the determined class. For example, the electronic device may initially classify the new candidate object based on the frequency of appearance of the new candidate object. For example, when the frequency of appearance of the new candidate object is less than or equal to a first threshold frequency (e.g., 2 times), the electronic device may initially classify the new candidate object as an object of non-interest. When the frequency of appearance of the new candidate object exceeds the first threshold frequency (e.g., 2 times) and is less than or equal to a second threshold frequency (e.g., 10 times), the electronic device may initially classify the new candidate object as an unclassified object. When the frequency of appearance of the new candidate object exceeds the second threshold frequency (e.g., 10 times), the electronic device may initially classify the new candidate object as an object of interest.

According to an embodiment, the electronic device may display, on the classification setting interface 600-1, each of the plurality of graphical representations with a size based on the frequency of appearance of a corresponding candidate object. For example, the electronic device may determine, for each candidate object, the number of images in which a corresponding candidate object is detected among the plurality of images as the frequency of appearance of the candidate object. The electronic device may display each candidate object with the size determined based on the frequency of appearance of each candidate object. As the frequency of appearance of a candidate object is higher (e.g., the number of images in which the candidate object is detected is greater), the electronic device may display a graphical representation corresponding to the candidate object with a larger size.

Referring to FIG. 6, in the classification setting interface 600-1, the frequency of appearance of a candidate object corresponding to the graphical representation 603-1 may be higher than the frequency of appearance of a candidate object corresponding to the graphical representation 605-1, and the electronic device may display the graphical representation 603-1 to be larger than the graphical representation 605-1. The electronic device may visually represent (or visualize) the frequency of appearance of a candidate object using the size of a graphical representation corresponding to the candidate object in the classification setting interface 600-1.

The electronic device may select, as the target image, an image including a candidate object based on the frequency of appearance of the candidate object. For example, when the frequency of appearance of the candidate object is higher, a likelihood of selecting the image including the candidate object as the target image may increase. The electronic device may visualize the likelihood of selecting the image including the candidate object as the target image by displaying a graphical representation corresponding to the candidate object with the size that is based on the frequency of appearance of the candidate object.

The electronic device may acquire a user input that adjusts information about a candidate object, from the classification setting interface 600-1. The electronic device may display information updated based on the acquired user input on the classification setting interface 600-2. Various examples of the user input that adjusts information about a candidate object are described below.

According to an embodiment, based on a user input (e.g., drag and drop) that moves at least one graphical representation, the electronic device may change a position of the at least one graphical representation among the plurality of graphical representations. The electronic device may classify a corresponding candidate object based on an area including the position of the graphical representation corresponding to the candidate object among the interest object area 610, the non-interest object area 620, or the unclassified objects area 630. For example, in a case where the position of the at least one graphical representation changes from one of the interest object area 610, the non-interest object area 620, and the unclassified object area 630 to another area, the electronic device may change a class of the at least one graphical representation from a class corresponding to one of the interest object area 610, the non-interest object area 620, and the unclassified object area 630 to a class corresponding to the other area.

Referring to FIG. 6, the electronic device may classify candidate objects corresponding to the graphical representations 608-1 and 609-1 as unclassified objects based on positions of the graphical representations 608-1 and 609-1 in the classification setting interface 600-1. The electronic device may detect, from the classification setting interface 600-1, a user input that moves the graphical representations 608-1 and 609-1 located in the unclassified object area 630 to the non-interest object area 620. The electronic device may display graphical representations 608-2 and 609-2 in the non-interest object area 620, in the classification setting interface 600-2. The electronic device may classify candidate objects corresponding to the graphical representations 608-2 and 609-2 as objects of non-interest based on positions of the graphical representations 608-2 and 609-2 in the classification setting interface 600-2.

According to an embodiment, when, in response to a user input that moves at least one graphical representation, the electronic device changes a position of the at least one graphical representation, a distance between the graphical representations may change. The electronic device may determine, based on the distance between the graphical representations corresponding to candidate objects, a likelihood of selecting, as the target image, an image in which the candidate objects appear together. The distance between the graphical representations may be calculated as a distance between center points of bounding boxes enclosing the graphical representations. For example, based on a distance between a first graphical representation corresponding to a first candidate object and a second graphical representation corresponding to a second candidate object among the plurality of candidate objects, the electronic device may adjust a likelihood of selecting an image including the first candidate object and the second candidate object as the target image from among the plurality of images.

For example, when the distance between the first graphical representation and the second graphical representation is less than or equal to a threshold distance, the electronic device may increase the likelihood of selecting the image including both the first candidate object and the second candidate object as the target image. When the distance between the first graphical representation and the second graphical representation is less than or equal to the threshold distance, the electronic device may apply a visual effect indicating that the distance between the first graphical representation and the second graphical representation is less than or equal to the threshold distance. The visual effect may include, for example, providing a line (e.g., a straight line and/or a curved line) surrounding the first graphical representation and the second graphical representation, overlaying a visual object that covers at least a portion of an area corresponding to the first graphical representation and the second graphical representation and has a determined transparency, or changing a visual property (e.g., color, brightness, or saturation) of the area corresponding to the first graphical representation and the second graphical representation.

According to an embodiment, the electronic device may group three or more graphical representations based on a distance between the graphical representations. For example, when the distance between the first graphical representation and the second graphical representation is less than or equal to the threshold distance, the electronic device may group the first candidate object and the second candidate object into a candidate object group. In this case, when a distance between at least one of the first graphical representation or the second graphical representation and a third graphical representation corresponding to a third candidate object is less than or equal to the threshold distance, the electronic device may add the third candidate object to the candidate object group. The electronic device may apply a visual effect to the graphical representations corresponding to the candidate objects belonging to the same candidate object group. The electronic device may adjust (e.g., increase) a likelihood of selecting, as the target image, an image including two or more candidate objects belonging to a candidate object group. The electronic device may adjust the likelihood to be greater as the number of candidate objects belonging to the candidate object group in the image is greater.

Referring to FIG. 6, the electronic device may acquire a user input that moves the graphical representations 604-1, 605-1, and 606-1 in the classification setting interface 600-1. The electronic device may display graphical representations 604-2, 605-2, and 606-2 at changed positions in the classification setting interface 600-2 based on the user input. Based on the positions of the graphical representations 604-2, 605-2, and 606-2 in the classification setting interface 600-2, the electronic device may group candidate objects corresponding to the graphical representations 604-2, 605-2, and 606-2 into one candidate object group. For example, the electronic device may display a line 650 surrounding the graphical representations 604-2, 605-2, and 606-2 as a visual effect indicating that the graphical representations 604-2, 605-2, and 606-2 are grouped into one candidate object group. The electronic device may adjust a likelihood of selecting, as the target image, an image including two or more of the candidate objects corresponding to the graphical representations 604-2, 605-2, and 606-2.

According to an embodiment, when a position of at least one graphical representation is changed in response to a user input that moves the at least one graphical representation, there may be an overlap between the graphical representations.

According to an embodiment, the electronic device may determine, based on an overlapping area of a first graphical representation and a second graphical representation among the plurality of graphical representations, that a first candidate object corresponding to the first graphical representation is the same object as a second candidate object corresponding to the second graphical representation. The overlapping area between the first graphical representation and the second graphical representation may be determined by an overlapping area between a bounding box of the first graphical representation and a bounding box of the second graphical representation. In this case, when a size of the overlapping area exceeds a threshold size, the electronic device may determine that the first candidate object is the same object as the second candidate object.

However, embodiments are not limited thereto, and the electronic device may determine that the first candidate object is the same object as the second candidate object based on a result of comparing an intersection over union (IoU) between the first graphical representation and the second graphical representation to a threshold value.

According to an embodiment, even if the electronic device initially determined that the first candidate object and the second candidate object are different objects, the electronic device may change the determination to one that the first candidate object and the second candidate object are the same object based on the user input. According to an embodiment, due to a great difference in appearance between a specific object in a first image and a specific object in a second image, the electronic device may incorrectly determine the first candidate object detected in the first image and the second candidate object as different objects. By moving the first graphical representation and/or the second graphical representation, the user may adjust that the first candidate object and the second candidate object are the same object.

According to an embodiment, the electronic device may integrate another candidate object (e.g., the second candidate object) into one candidate object (e.g., the first candidate object) of the first candidate object and the second candidate object. For example, the electronic device may replace an object identifier of the second candidate object with an object identifier of the first candidate object in an image mapped to the object identifier of the second candidate object among the plurality of images. The electronic device may adjust (e.g., update) the frequency of appearance of the first candidate object by adding the frequency of appearance of the second candidate object to the frequency of appearance of the first candidate object. For example, the electronic device may stop displaying the second graphical representation and display the first graphical representation with an adjusted (e.g., increased) size based on the adjusted frequency of appearance.

Referring to FIG. 6, the candidate objects corresponding to the graphical representation 601-1 and the graphical representation 602-1 are identified as different objects, but may actually be the same person only with different hairstyles. The electronic device may acquire a user input that moves the graphical representation 602-1 toward the graphical representation 601-1, in the classification setting interface 600-1. The electronic device may determine, based on an overlapping area between the graphical representation 602-1 and the graphical representation 601-1, that the candidate object corresponding to the graphical representation 602-1 is the same object as the candidate object corresponding to the graphical representation 601-1. In the classification setting interface 600-2, the electronic device may not display the graphical representation 602-1, but may display the graphical representation 602-2 with an adjusted size.

According to an embodiment, the electronic device may acquire a user input that adjusts a size of at least one graphical representation among the plurality of graphical representations respectively corresponding to the plurality of candidate objects. The electronic device may adjust the size of the at least one graphical representation based on the user input. The electronic device may adjust, based on the adjusted size, a likelihood of selecting, as the target image, an image including a candidate object corresponding to the at least one graphical representation.

For example, when acquiring a user input that decreases the size of the at least one graphical representation, the electronic device may decrease the size of the at least one graphical representation and decrease the likelihood of selecting, as the target image, the image including the candidate object corresponding to the at least one graphical representation.

For example, when acquiring a user input that increases the size of the at least one graphical representation, the electronic device may increase the size of the at least one graphical representation and increase the likelihood of selecting, as the target image, the image including the candidate object corresponding to the at least one graphical representation.

Referring to FIG. 6, the electronic device may detect a user input that decreases the size of the graphical representation 603-1 displayed on the classification setting interface 600-1. The electronic device may display a graphical representation 603-2 with the decreased size on the classification setting interface 600-2. The electronic device may decrease a likelihood of selecting, as the target image, an image including a candidate object corresponding to the graphical representation 603-2.

FIG. 7 is a diagram illustrating an example of an operation of emphasizing, by an electronic device, a specific graphical representation on a classification setting interface, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may emphasize a specific graphical representation when displaying a classification setting interface 700.

According to an embodiment, when a candidate object-related event has occurred, the electronic device may display a corresponding candidate object by applying a visual effect to a graphical representation corresponding to the candidate object. For example, the candidate object-related event may include acquiring (e.g., receiving, capturing, generating, sharing, or storing) images including more than a threshold number (e.g., 10) of candidate objects within a determined time period (e.g., most recent three days).

According to an embodiment, the visual effect may include providing a line (e.g., a straight and/or curved line) that surrounds a graphical representation, overlaying a visual object that covers at least a portion of the graphical representation and has a determined transparency, or changing a visual property (e.g., color, brightness, or saturation) of the graphical representation.

However, in various embodiments of the present disclosure, the candidate object-related event is not limited to acquiring an image of a candidate object. For example, the candidate object-related event may include an event based on communication with a device associated with the candidate object (e.g., transmitting or receiving a call or message) or an event based on the arrival of a date related to the candidate object.

Referring to FIG. 7, the electronic device may display graphical representations corresponding to a plurality of candidate objects on the classification setting interface 700. When there is an event for a specific object among the plurality of candidate objects, the electronic device may display the specific object by applying a visual effect to a graphical representation 701 corresponding to the specific object. For example, the electronic device may overlay, on the graphical representation 701, a visual object 702 that covers the graphical representation 701 and has a determined transparency.

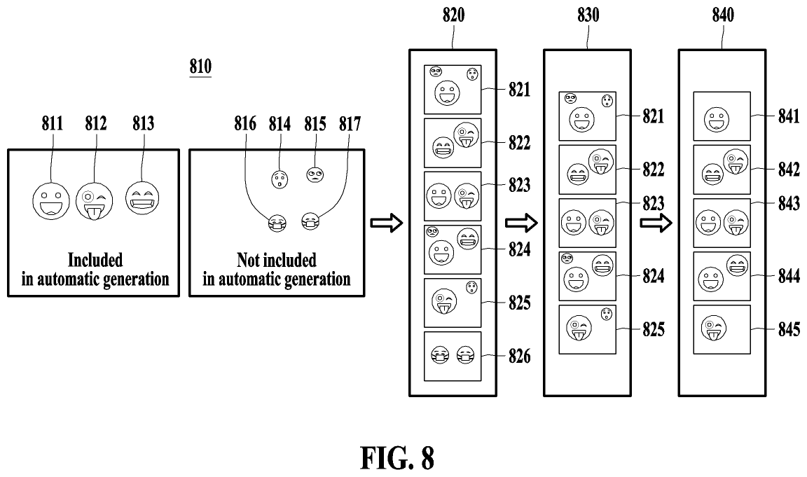

FIG. 8 is a diagram illustrating an example of an operation of selecting, by an electronic device, a conversion image from a target image based on a classification result, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may generate a conversion image from a target image based on a classification result (e.g., a first classification result or a second classification result).

For example, the electronic device may acquire a user input that transmits (e.g., shares) a specific image to another device. The electronic device may determine the specific image as the target image and generate a conversion image in which an object of non-interest of the classification result is excluded from the target image based on the classification result. The electronic device may share the conversion image instead of the target image.

For example, the electronic device may acquire a user input that selects a specific image as a setup image. The setup image may be an image that is set as at least a portion of a specific screen based on the user input and may include, for example, an image that forms at least a portion (e.g., a background) of a home screen and/or a lock screen. The electronic device may determine, as the target image, the specific image selected as the setup image. The electronic device may generate one or more conversion images from the target image. The electronic device may display one of the one or more conversion images in place of the target image. The one conversion image to be displayed among the one or more conversion images may be determined according to a display condition. How the conversion image is displayed according to the display condition is described in more detail below with reference to FIGS. 10 through 12.

The electronic device may acquire a classification result 810 via a classification setting interface (e.g., the classification setting interfaces 600-1 and 600-2 of FIG. 6, or the classification setting interface 700 of FIG. 7). Referring to FIG. 8, the classification result 810 may include a result of classifying seven candidate objects (e.g., a first candidate object 811 through a seventh candidate object 817) as objects of interest or objects of non-interest. In the classification result 810, the first candidate object 811, the second candidate object 812, and the third candidate object 813 may be classified as the objects of interest, and the fourth candidate object 814, the fifth candidate object 815, the sixth candidate object 816, and the seventh candidate object 817 may be classified as the objects of non-interest.

The electronic device may select a target image 830 from among a plurality of images 820. The electronic device may select, as the target image 830, an image including at least one object of interest in the classification result 810 from among the plurality of images 820. The electronic device may exclude, from the target image 830, an image without an object of interest (e.g., an image including only an object of non-interest) among the plurality of images 820. However, the electronic device does not necessarily exclude an image without an object of interest among a plurality of images from a target image, but the electronic device may adjust a likelihood of selecting that image without the object of interest as the target image from among the plurality of images to be low. That is, despite such a low likelihood, the electronic device may still select, as the target image, the image without the object of interest.

Referring to FIG. 8, the plurality of images 820 may include a first image 821 through a sixth image 826. The first image 821 may include the first candidate object 811, the fourth candidate object 814, and the fifth candidate object 815. The second image 822 may include the second candidate object 812 and the third candidate object 813. The third image 823 may include the first candidate object 811 and the second candidate object 812. The fourth image 824 may include the first candidate object 811, the third candidate object 813, and the fifth candidate object 815. The fifth image 825 may include the second candidate object 812 and the fourth candidate object 814. The sixth image 826 may include the sixth candidate object 816 and the seventh candidate object 817. The electronic device may not select, as the target image 830, the sixth image 826 without an object of interest from among the plurality of images 820. For example, the electronic device may select, as the target image 830, the first image 821 through the fifth image 825 including at least one object of interest from among the plurality of images 820.

Although an example where all the first image 821 through the fifth image 825 including at least one object of interest are selected as the target image 830 is primarily described with reference to FIG. 8, examples are not limited thereto. For example, the electronic device may also select, as the target image 830, some images (e.g., the second image 822, the third image 823, and the fourth image 824) from among the images (e.g., the first image 821 through the fifth image 825) including at least one object of interest.

According to an embodiment, the electronic device may generate a conversion image from the target image 830 by retaining the objects of interest and excluding the objects of non-interest of the classification result 810. For example, excluding the objects of non-interest from the target image 830 may include deleting the objects of non-interest using image inpainting if they appear in the target image 830. If the objects of non-interest do not appear in the target image 830, image inpainting may not be applied because the objects of non-interest have already been excluded from the target image 830.

Referring to FIG. 8, the electronic device may generate a plurality of conversion images 840 based on the target image 830 including the first image 821 through the fifth image 825.

For example, the electronic device may acquire a conversion image 841 from the first image 821 of the target image 830 by excluding the fourth candidate object 814 and the fifth candidate object 815 and retaining the first candidate object 811. The electronic device may acquire the second image 822 as a conversion image 842 based on the objects of non-interest of the classification result 810 not appearing in the second image 822 of the target image 830. The electronic device may acquire the third image 823 as a conversion image 843 based on the objects of non-interest of the classification result 810 not appearing in the third image 823 of the target image 830. The electronic device may acquire a conversion image 844 from the fourth image 824 of the target image 830 by excluding the fifth candidate object 815 and retaining the first candidate object 811 and the third candidate object 813. The electronic device may acquire a conversion image 845 from the fifth image 825 of the target image 830 by excluding the fourth candidate object 814 and retaining the second candidate object 812.

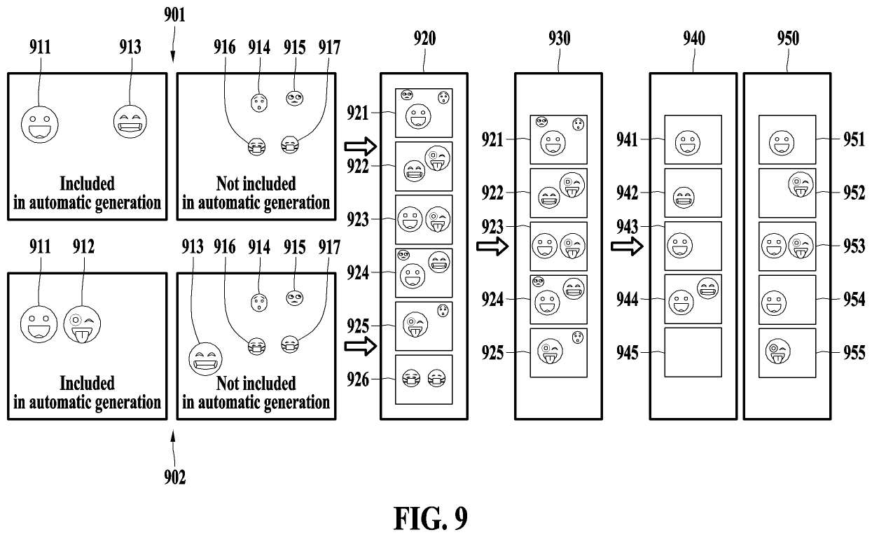

FIG. 9 is a diagram illustrating an example of an operation of selecting, by an electronic device, a conversion image from a target image based on a classification result, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may generate a plurality of conversion images from a target image 930 based on a plurality of classification results corresponding to a plurality of display conditions.

According to an embodiment, the electronic device may acquire a first classification result 901 corresponding to a first display condition and a second classification result 902 corresponding to a second display condition via a classification setting interface (e.g., the classification setting interfaces 600-1 and 600-2 of FIG. 6, or the classification setting interface 700 of FIG. 7).

Referring to FIG. 9, the first classification result 901 and the second classification result 902 may each include a result of classifying seven candidate objects (e.g., a first candidate object 911 through a seventh candidate object 917) as objects of interest or objects of non-interest.

For example, in the first classification result 901, the first candidate object 911 and the third candidate object 913 may be classified as the objects of interest. In the first classification result 901, the second candidate object 912, the fourth candidate object 914, the fifth candidate object 915, the sixth candidate object 916, and the seventh candidate object 917 may be classified as the objects of non-interest.

For example, in the second classification result 902, the first candidate object 911 and the second candidate object 912 may be classified as the objects of interest. In the second classification result 902, the third candidate object 913, the fourth candidate object 914, the fifth candidate object 915, the sixth candidate object 916, and the seventh candidate object 917 may be classified as the objects of non-interest.

According to an embodiment, the electronic device may select a target image 930 from among a plurality of images 920. The electronic device may select, as the target image 930, an image including at least one of the objects of interest in the first classification result 901 or at least one of the objects of interest in the second classification result 902 from among the plurality of images 920. The electronic device may exclude, from the target image 930, an image without an object of interest (e.g., an image including only an object of non-interest), among the plurality of images 920.

However, the electronic device does not necessarily exclude, from the target image 930, an image without an object of interest of the first classification result 901 and the second classification result 902, but the electronic device may adjust a likelihood of selecting, as the target image 930, an image without an object of interest of the first classification result 901 and the second classification result 902 from among the plurality of images 920 to be low. That is, despite such a low likelihood, the electronic device may still select, as the target image 930, an image without an object of interest of the first classification result 901 and the second classification result 902.

Referring to FIG. 9, the plurality of images 920 may include, for example, a first image 921 through a sixth image 926. The first image 921 may include the first candidate object 911, the fourth candidate object 914, and the fifth candidate object 915. The second image 922 may include the second candidate object 912 and the third candidate object 913. The third image 923 may include the first candidate object 911 and the second candidate object 912. The fourth image 924 may include the first candidate object 911, the third candidate object 913, and the fifth candidate object 915. The fifth image 925 may include the second candidate object 912 and the fourth candidate object 914. The sixth image 926 may include the sixth candidate object 916 and the seventh candidate object 917. For example, the electronic device may not select, as the target image 930, the sixth image 926 without an object of interest among the plurality of images 920. The electronic device may select, as the target image 930, the first image 921 through the fifth image 925 including at least one of the objects of interest of the first classification result 901 or the second classification result 902 from among the plurality of images 920.

Although an example where all the first image 921 through the fifth image 925 including at least one of the objects of interest of the first classification result 901 or the second classification result 902 are selected as the target image 930 is primarily described with reference to FIG. 9, examples are not limited thereto. For example, the electronic device may also select, as the target image 930, the second image 922, the third image 923, and the fourth image 924 including all the objects of interest in both the first classification result 901 and the second classification result 902.

According to an embodiment, the electronic device may generate, from the target image 930, a conversion image corresponding to a corresponding classification result (or a display condition corresponding to that classification result) by retaining objects of interest of each classification result and excluding objects of non-interest of each classification result.

Referring to FIG. 9, the electronic device may generate, from the target image 930 including the first image 921 through the fifth image 925, first conversion images 940 based on the first classification result 901 and second conversion images 950 based on the second classification result 902.

For example, the electronic device may generate a first conversion image 941 of the first image 921 from the first image 921 of the target image 930 by excluding the fourth candidate object 914 and the fifth candidate object 915, which are the objects of non-interest of the first classification result 901, and retaining the first candidate object 911, which is the object of interest of the first classification result 901. The electronic device may generate a second conversion image 951 of the first image 921 from the first image 921 of the target image 930 by retaining the first candidate object 911, which is the object of interest of the second classification result 902, and excluding the fourth candidate object 914 and the fifth candidate object 915, which are the objects of non-interest of the second classification result 902.

For example, the electronic device may generate a first conversion image 942 of the second image 922 from the second image 922 of the target image 930 by excluding the second candidate object 912, which is the object of non-interest of the first classification result 901, and retaining the third candidate object 913, which is the object of interest of the first classification result 901. The electronic device may generate a second conversion image 952 of the second image 922 from the second image 922 of the target image 930 by excluding the third candidate object 913, which is the object of non-interest of the second classification result 902, and retaining the second candidate object 912, which is the object of interest of the second classification result 902.

For example, the electronic device may generate a first conversion image 943 of the third image 923 from the third image 923 of the target image 930 by excluding the second candidate object 912, which is the object of non-interest of the first classification result 901, and retaining the first candidate object 911, which is the object of interest of the first classification result 901. The electronic device may acquire the third image 923 as a second conversion image 953 of the third image 923, based on the object of non-interest of the second classification result 902 not appearing in the third image 923 of the target image 930.

For example, the electronic device may generate a first conversion image 944 of the fourth image 924 from the fourth image 924 of the target image 930 by excluding the fifth candidate object 915, which is the object of non-interest of the first classification result 901, and retaining the first candidate object 911 and the third candidate object 913, which are the objects of interest of the first classification result 901. The electronic device may generate a second conversion image 954 of the fourth image 924 from the fourth image 924 of the target image 930 by retaining the first candidate object 911, which is the object of interest of the second classification result 902, and excluding the third candidate object 913 and the fifth candidate object 915, which are the objects of non-interest of the second classification result 902.

For example, the electronic device may generate a first conversion image 945 of the fifth image 925 from the fifth image 925 of the target image 930 by excluding the second candidate object 912 and the fourth candidate object 914, which are the objects of non-interest of the first classification result 901. The electronic device may generate a second conversion image 955 of the fifth image 925 from the fifth image 925 of the target image 930 by retaining the second candidate object 912, which is the object of interest of the second classification result 902, and excluding the fourth candidate object 914, which is the object of non-interest of the second classification result 902.

Although not explicitly shown in FIG. 9, among conversion images for a specific classification result, conversion images without objects of interest of the specific classification result may be excluded. For example, of the first conversion images 940 for the first classification result 901, the first conversion image 945 of the fifth image 925 without the objects of interest of the first classification result 901 may be excluded from the first conversion images 940. For example, of the second conversion images 950 for the second classification result 902, the second conversion image 951 of the first image 921 without the objects of interest of the second classification result 902 may be excluded from the second conversion images 950. The electronic device may display at least one of the first conversion images 940 of the first image 921, the second image 922, the third image 923, and the fourth image 924 while satisfying the first display condition. The electronic device may display at least one of the second conversion images 950 of the second image 922, the third image 923, the fourth image 924, and the fifth image 925 while satisfying the second display condition.

FIG. 10 is a diagram illustrating an example of an operation of displaying, by an electronic device, conversion images based on display conditions for an image displaying area of a display, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may display one of a plurality of conversion images according to a plurality of display conditions for an image displaying area in a display in which an image is displayed.

According to an embodiment, a target image 1010 may include a first candidate object 1011 and a second candidate object 1012. In a first classification result, the first candidate object 1011 and the second candidate object 1012 may be classified as objects of interest. In a second classification result, the first candidate object 1011 may be classified as an object of non-interest, and the second candidate object 1012 may be classified as an object of interest. As described above with reference to FIG. 9, the electronic device may generate, from the target image 1010, a first conversion image 1021 in which the first candidate object 1011 and the second candidate object 1012 are retained. The electronic device may generate, from the target image 1010, a second conversion image 1022 in which the first candidate object 1011 is excluded and the second candidate object 1012 is retained.

In the example of FIG. 10, the electronic device may acquire a user input that sets one of a plurality of images as a setup image. The electronic device may select, as the target image 1010, an image selected as the setup image based on the user input. In this case, when the display of the electronic device includes a plurality of areas and/or a plurality of displays, the setup image may be displayed in the plurality of areas and/or on the plurality of displays. Based on the user input that sets the target image 1010 as the setup image, the electronic device may generate, from the target image 1010, a plurality of conversion images based on the display conditions.

For example, the display of the electronic device may include a first area (e.g., the first area 251 of FIGS. 2A through 2D) and a second area (e.g., the second area 252 of FIGS. 2A through 2D). A first display condition may include displaying an image in the first area. A second display condition may include displaying an image in the second area. The electronic device may display a first conversion image in the first area based on displaying an image generated from a target image in the first area. The electronic device may display a second conversion image in the second area based on displaying an image generated from the target image in the second area.

For example, the display of the electronic device may include a main display capable of changing a state and a sub-display. A state of the electronic device may be switchable between a plurality of states, including a first state 1030 (e.g., at least partially unfolded) or a second state 1040 (e.g., folded), based on a change in a folding angle of the main display. The first display condition may include displaying an image on the main display. The second display condition may include displaying an image on the sub-display.

For example, whether the electronic device displays an image on the main display or the sub-display may be determined by the state of the electronic device. For example, while the electronic device is in the first state 1030 (e.g., at least partially unfolded), the electronic device may activate the main display and deactivate the sub-display. While the electronic device is in the second state 1040 (e.g., folded), the electronic device may deactivate the main display and activate the sub-display.

When the electronic device is in the first state 1030 (e.g., at least partially unfolded), the electronic device may determine that the first display condition for displaying an image on the main display is satisfied. Accordingly, the electronic device may display the first conversion image 1021 on the main display while the electronic device is in the first state 1030 (e.g., at least partially unfolded).

When the electronic device is in the second state 1040 (e.g., folded), the electronic device may determine that the second display condition for displaying an image on the sub-display is satisfied. Accordingly, the electronic device may display the second conversion image 1022 on the sub-display while the electronic device is in the second state 1040.

When the state of the electronic device is changed, the displayed image may also change (e.g., switch) between the first conversion image 1021 and the second conversion image 1022.

For example, the electronic device may display the first conversion image 1021 on the main display while the electronic device is in the first state 1030. When the state of the electronic device is changed (e.g., switched) from the first state 1030 to the second state 1040, the electronic device may stop displaying the first conversion image 1021 on the main display and may display the second conversion image 1022 on the sub-display.

For example, the electronic device may display the second conversion image 1022 on the sub-display while the electronic device is in the second state 1040. When the state of the electronic device is changed (e.g., switched) from the second state 1040 to the first state 1030, the electronic device may stop displaying the second conversion image 1022 on the sub-display and may display the first conversion image 1021 on the main display.

FIG. 11 is a diagram illustrating an example of an operation of displaying, by an electronic device, conversion images based on display conditions for an image displaying time at which an image is displayed, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may display one of a plurality of conversion images according to a plurality of display conditions for an image displaying time at which an image is displayed.

For example, a target image 1110 may include a first candidate object 1111, a second candidate object 1112, and a third candidate object 1113. In a first classification result, the first candidate object 1111 and the second candidate object 1112 may be classified as objects of interest, and the third candidate object 1113 may be classified as an object of non-interest. In a second classification result, the first candidate object 1111 and the third candidate object 1113 may be classified as objects of non-interest, and the second candidate object 1112 may be classified as an object of interest. As described above with reference to FIG. 9, the electronic device may generate, from the target image 1110, a first conversion image 1121 in which the first candidate object 1111 and the second candidate object 1112 are retained and the third candidate object 1113 is excluded. The electronic device may generate, from the target image 1110, a second conversion image 1122 in which the first candidate object 1111 and the third candidate object 1113 are excluded and the second candidate object 1112 is retained.

In the example of FIG. 11, the electronic device may acquire a user input that sets the target image 1110 as a background for a home screen and/or a lock screen. The home screen or the lock screen may be displayed repeatedly at a plurality of timepoints. For example, the electronic device may generate, based on the user input that sets the target image 1110 as the background of the home screen and/or the lock screen, a plurality of conversion images from the target image 1110 according to a plurality of display conditions for an image displaying time at which an image is to be displayed.

For example, a first display condition may include displaying an image at the image displaying time included in a first time range (e.g., a range from 9:00 a.m. to before 6:00 p.m. each day). A second display condition may include displaying an image at the image displaying time included in a second time range (e.g., from 6:00 p.m. each day to before 9:00 a.m. the next day) that is different from the first time range.

On a screen 1130, the electronic device may display the first conversion image 1121 based on a timepoint of display falling within the first time range. The timepoint of display may refer to a point in time at which one of the conversion images generated from the target image 1110 is displayed. On a screen 1140, the electronic device may display the second conversion image 1122 based on the timepoint of display falling within the second time range.

According to an embodiment, as time elapses, the electronic device may switch an image to be displayed, between the first conversion image 1121 and the second conversion image 1122.

For example, the second time range of the second display condition may include a time range that is temporally subsequent to at least a portion of the first time range of the first display condition. For example, the second time range may be temporally subsequent to the first time range. The electronic device may display the first conversion image 1121 based on the timepoint of display being included in the first time range. When the timepoint of display falls within the second time range after being out of the first time range as time elapses, the electronic device may change an image to be displayed, from the first conversion image 1121 to the second conversion image 1122.

Conversely, the second time range of the first display condition may include a time range that is temporally subsequent to at least a portion of the first time range of the first display condition. The electronic device may display the second conversion image 1122 based on the timepoint of display being included in the second time range. When the timepoint of display falls within the first time range after being out of the second time range as time elapses, the electronic device may change an image to be displayed, from the second conversion image 1122 to the first conversion image 1121.

FIG. 12 is a diagram illustrating an example of an operation of displaying, by an electronic device, conversion images based on display conditions for an image displaying device, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may display one of a plurality of conversion images according to a plurality of display conditions for an image displaying device.

For example, as shown in FIG. 12, a target image 1210 may include a first candidate object 1211, a second candidate object 1212, and a third candidate object 1213. In a first classification result, the first candidate object 1211 and the second candidate object 1212 may be classified as objects of interest, and the third candidate object 1213 may be classified as an object of non-interest. In a second classification result, the first candidate object 1211 and the third candidate object 1213 may be classified as objects of non-interest, and the second candidate object 1212 may be classified as an object of interest. The electronic device may generate, from the target image 1210, a first conversion image 1221 in which the first candidate object 1211 and the second candidate object 1212 are retained and the third candidate object 1213 is excluded. The electronic device may generate, from the target image 1210, a second conversion image 1222 in which the first candidate object 1211 and the third candidate object 1213 are excluded and the second candidate object 1212 is retained.

In the example of FIG. 12, the electronic device may acquire a user input that indicates setting a specific image (e.g., the target image 1210) as a setup image common to a plurality of devices (e.g., the electronic device and another electronic device). The electronic device may generate a plurality of conversion images based on a plurality of display conditions associated with the plurality of devices, using a classification result determined for each device.

For example, a first display condition may include displaying an image on the electronic device, and a second display condition may include displaying an image on another electronic device.

On a screen 1230, the electronic device may display the first conversion image 1221 as the setup image for the electronic device, based on acquiring the user input that sets the target image 1210 as the setup image common to the electronic device and the other electronic device.

The electronic device may transmit the second conversion image 1222 to the other electronic device to allow the other electronic device to display the second conversion image 1222 as the setup image of the other electronic device. The other electronic device may receive the second conversion image 1222 from the electronic device. On a screen 1240, the other electronic device may display the second conversion image 1222 as the setup image of the other electronic device.

However, the other electronic device does not necessarily receive the second conversion image 1222 directly from the electronic device, but the other electronic device may receive the second conversion image 1222 from the electronic device via a server or cloud device. For example, the electronic device may transmit (e.g., upload) the generated second conversion image 1222 to the server or cloud device. The other electronic device may then receive the second conversion image 1222 from the server or cloud device.

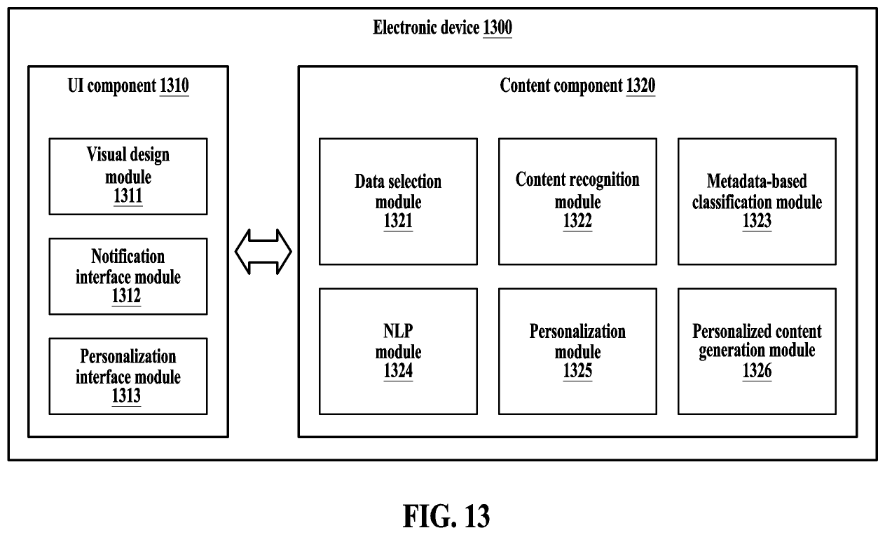

FIG. 13 is a block diagram illustrating an example configuration of an electronic device, according to various embodiments.

An electronic device 1300 according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may include a user interface component 1310 (also referred to herein as “UI component”) and a content component 1320.

According to an embodiment, the UI component 1310 may refer to a software and/or hardware component that provides a UI (e.g., a classification setting interface) and performs functions to acquire a user input via the interface and display content (e.g., target images or conversion images) acquired from the content component 1320.

According to an embodiment, the content component 1320 may refer to a software and/or hardware component that performs functions to acquire user settings (e.g., classification results) and generates and/or stores content (e.g., target images or conversion images) based on a user input acquired via the UI component 1310.

According to an embodiment, the UI component 1310 may include a visual design module 1311, a notification interface module 1312, and a personalization interface module 1313.

According to an embodiment, the visual design module 1311 may apply visual effects to content acquired from the content component 1320. For example, the visual effects may include automatic sliding, scrolling, playing, and/or switching effects for a content set including one or more pieces of content.

According to an embodiment, in response to receiving information indicating that content (e.g., a conversion image) has been generated by the content component 1320, the notification interface module 1312 may cause the electronic device to output a notification. The notification interface module 1312 may provide the generated content to the visual design module 1311 such that the generated content is added to a content set to be provided to the user.

According to an embodiment, the personalization interface module 1313 may provide a UI (e.g., a classification setting interface) for acquiring a user input for determining a classification result to reflect a user's preference for a plurality of candidate objects. The personalization interface module 1313 may provide a classification setting interface and may determine a classification result based on a user input acquired via the classification setting interface. The personalization interface module 1313 may provide a classification setting interface for each display condition and may determine a classification result for each display condition.

According to an embodiment, the content component 1320 may include a data selection module 1321, a content recognition module 1322, a metadata-based classification module 1323, a natural language processing (NLP) module 1324, a personalization module 1325, and a personalized content generation module 1326, each of which may comprise processing circuitry.

According to an embodiment, the data selection module 1321 may access a repository (not shown) that stores content (e.g., images) accessible by the electronic device, stores generated content, or stores user settings (e.g., classification results) and/or data related to models (e.g., a machine learning model and an inpainting model). The repository, a data storage space, may store content (e.g., images or videos) and metadata of the content.

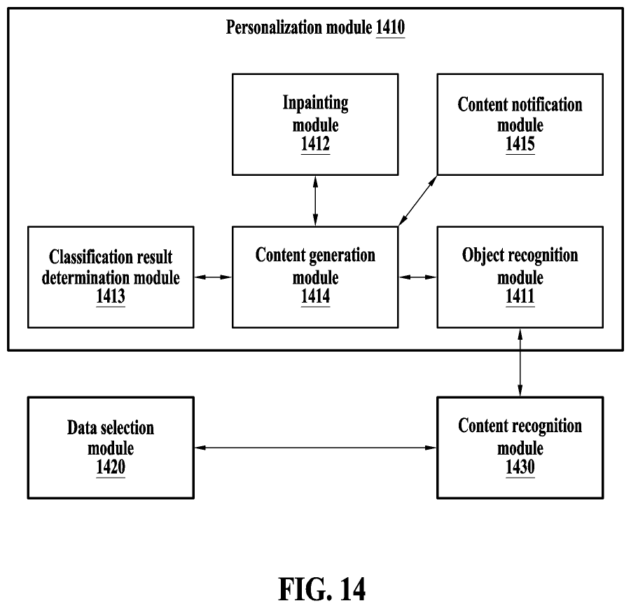

According to an embodiment, the repository may be implemented as a single repository or distributed repositories to ensure the integrity and consistency of data stored in the repository. According to an embodiment, the repository may be implemented in the form of a database (DB) or file system. The data selection module 1321 is further described below with reference to FIG. 14.

According to an embodiment, the content recognition module 1322 may analyze content (e.g., an image or a video including a plurality of frame images) to analyze the relevance between the content and candidate objects. For example, the content recognition module 1322 may analyze whether the content relates to a candidate object (e.g., a person or a pet) (e.g., whether the candidate object appears in the content), where in the content the candidate object is related (e.g., where in the content does the candidate object appear), how related the content is to the candidate object (e.g., how large or prominent the candidate object appears in the image), and/or if the content is related to a plurality of candidate objects, what is the relationship between the plurality of candidate objects (e.g., determining the affinity and/or mood between the candidate objects).

According to an embodiment, the metadata-based classification module 1323 may classify and/or select content based on user settings (e.g., classification results) and content generation settings based on metadata mapped to the content.

According to an embodiment, the NLP module 1324 may analyze a natural language recognized in content (e.g., an image or video) and, when the content is generated, generate a title and/or body in the form of the natural language from the metadata.

According to an embodiment, the personalization module 1325 may process (e.g., modify, edit, and/or enhance) an image (e.g., a target image) stored in the repository based on user settings (e.g., classification results) to transform (or convert) it into a media form (e.g., a conversion image) desired by the user. The personalization module 1325 is further described below with reference to FIG. 14.

According to an embodiment, the personalized content generation module 1326 may generate content to be provided to the user based on processing results from the content recognition module 1322, the metadata-based classification module, the NLP module 1324, and/or the personalization module 1325.

FIG. 14 is a block diagram illustrating an example configuration of an electronic device, according to various embodiments.

An electronic device according to an embodiment (e.g., the electronic device 101 of FIG. 1, the electronic device 200 of FIGS. 2A through 2D, the electronic device 300 of FIGS. 3A through 3D, or the electronic device 400 of FIG. 4) may include a personalization module 1410 (e.g., the personalization module 1325 of FIG. 13), a data selection module 1420 (e.g., the data selection module 1321 of FIG. 13), and/or a content recognition module 1430 (e.g., the content recognition module 1322 of FIG. 13).

According to an embodiment, the data selection module 1420 may provide only some content (e.g., some images) specified by the user among data stored in a repository as an input for generating content. The data selection module 1420 may use the content specified by the user to form a guideline for generating an image desired by the user. The content specified by the user (e.g., a plurality of images) may be a portion of the data accessible by the electronic device that is specified (e.g., limited) to be provided as an input to a content generation module 1414. For example, some content may be specified based on a device storing an image, a directory (e.g., folder) storing an image, an application, or a service.

However, specifying content is not limited to specifying the data based on the device, the directory, the application, or the service. For example, the content may be further specified through user-specifiable conditions. The user-specifiable conditions may include, for example, a file type, a file creation date, a file name, equipment information, shooting settings information (e.g., aperture value, shutter speed, ISO sensitivity, or focal length), location information, editing program information, copyright information, image size, and/or color space.

According to an embodiment, the content recognition module 1430 may extract metadata from the content (e.g., an image or video) acquired from the data selection module 1420, as described above with reference to FIG. 13. The content recognition module 1430 may analyze the substance of the content (e.g., an image or video) to distinguish between candidate objects or determine (e.g., predict or infer) relationships between the candidate objects. The content recognition module 1430 may also determine the overall semantic information and context of the content.

Although not explicitly shown in FIG. 14, the content recognition module 1430 may include a content processing submodule, a feature extraction submodule, or a content recognition submodule. The content processing submodule may preprocess content. The feature extraction submodule may extract features from the preprocessed content. The content recognition submodule may determine and/or understand the substance of the content based on the features extracted by the feature extraction submodule. The operations of the content processing submodule, the feature extraction submodule, and the content recognition submodule included in the content recognition module 1430 described above may be performed on respective pieces of content. For example, the content recognition module 1430 may analyze each piece of content to determine the substance of a corresponding piece of content based on recognition results acquired by recognizing features of the content, candidate objects that appear in the content, a background of the content, and/or characters in the content.

According to an embodiment, the personalization module 1410 may include an object recognition module 1411, an inpainting module 1412, a classification result determination module 1413, a content generation module 1414, and/or a content notification module 1415.

According to an embodiment, the object recognition module 1411 may recognize and/or track the location and/or movement of candidate objects appearing among a plurality of pieces of content (e.g., a plurality of consecutive images or a plurality of videos) based on information acquired from the content recognition module 1430. The object recognition module 1411 may also recognize and/or track associations (or relationships) between the pieces of content to select topic-related data (e.g., a target image) for generating new content. The object recognition module 1411 may provide the selected data to the content generation module 1414. Each “module” herein may comprise circuitry.

According to an embodiment, the inpainting module 1412 may correct and/or modify content (e.g., an image or video). The inpainting module 1412 may remove candidate objects (e.g., objects of non-interest) from an image (or each frame image of a video) and may naturally reconstruct the removed portion.

According to an embodiment, the classification result determination module 1413 may determine a classification result based on at least one of a default classification result or a conditional classification result.

For example, the default classification result may refer to a classification result that is unique to the user, independent of a display condition (e.g., common to all display conditions). The default classification result may include a result of classifying a plurality of candidate objects as objects of interest or objects of non-interest, and/or information about relationships between the objects of interest, which is generally applicable to generating content based on the user's content.

For example, the conditional classification result may refer to a classification result that is related to (e.g., dependent on) a display condition. The conditional classification result may include a result of classifying a plurality of candidate objects as objects of interest or objects of non-interest for a specific display condition, and/or information about relationships between the objects of interest.

According to an embodiment, in response to a new display condition being specified, the classification result determination module 1413 may provide the default classification result as a default value for the conditional classification result, and acquire a classification result associated with the newly specified display condition based on a user input that changes the default classification result via a classification setting interface, as a classification result (e.g., a classification result to be used to generate a conversion image) corresponding to the display condition.

According to an embodiment, the classification result determination module 1413 may determine the classification result corresponding to the display condition by combining the classification result associated with the display condition determined via the classification setting interface with the default classification result. For example, it may determine a distance between objects of interest in the classification result corresponding to the display condition by calculating an average (e.g., arithmetic mean, harmonic mean, or geometric mean) of a distance between objects of interest in the classification result associated with the display condition and a distance between objects of interest in the default classification result.

According to an embodiment, the content generation module 1414 may generate new content (e.g., a conversion image) based on processing results from the data selection module 1420, the content recognition module 1430, the object recognition module 1411, the inpainting module 1412, and/or the classification result determination module 1413.

According to an embodiment, the content notification module 1415 may store the generated content in the repository and transmit, to an external party (e.g., the UI component 1310 of FIG. 13), information indicating that the new content has been generated.

According to embodiments, an electronic device (e.g., 101; 200; 300; 400; 1300) may include: a display (e.g., 160; 250; 330; 420); a processor (e.g., 120; 440); and a memory (e.g., 130) configured to store instructions, wherein the instructions may, when executed by the processor (e.g., 120; 440), cause the electronic device (e.g., 101; 200; 300; 400; 1300) to: detect a plurality of candidate objects from a plurality of images (e.g., 820; 920); determine a first classification result (e.g., 901) by classifying at least one of the plurality of candidate objects as an object of interest or an object of non-interest, based on a user input for a first display condition for at least one of an image displaying device that is a device for displaying an image, an image displaying area of a display of the image displaying device, or an image displaying time at which the image is displayed; determine a second classification result (e.g., 902), by classifying at least one of the plurality of candidate objects as an object of interest or an object of non-interest, based on a user input for a second display condition; generate, from a target image (e.g., 830; 930; 1010; 1110; 1210), a first conversion image (e.g., 940; 1021; 1121; 1221) corresponding to the first display condition by retaining the object of interest of the first classification result (e.g., 901) and excluding the object of non-interest of the first classification result (e.g., 901); generate, from the target image (e.g., 830; 930; 1010; 1110; 1210), a second conversion image (e.g., 950; 1022; 1122; 1222) corresponding to the second display condition by retaining the object of interest of the second classification result (e.g., 902) and excluding the object of non-interest of the second classification result (e.g., 902); display the first conversion image (e.g., 940; 1021; 1121; 1221) while the electronic device (e.g., 101; 200; 300; 400; 1300) satisfies the first display condition; and display the second conversion image (e.g., 950; 1022; 1122; 1222) while the electronic device (e.g., 101; 200; 300; 400; 1300) satisfies the second display condition.

The display (e.g., 160; 250; 330; 420) may include a first area and a second area. The first display condition may include displaying the image in the first area, and the second display condition may include displaying the image in the second area. The instructions may, when executed by the processor (e.g., 120; 440), cause the electronic device (e.g., 101; 200; 300; 400; 1300) to: based on displaying an image generated from the target image (e.g., 830; 930; 1010; 1110; 1210) in the first area, display the first conversion image (e.g., 940; 1021; 1121; 1221) in the first area; and based on displaying an image generated from the target image (e.g., 830; 930; 1010; 1110; 1210) in the second area, display the second conversion image (e.g., 950; 1022; 1122; 1222) in the second area.

The display (e.g., 160; 250; 330; 420) may include a main display (e.g., 250; 330; 420) capable of changing a state, and a sub-display. A state of the electronic device (e.g., 101; 200; 300; 400; 1300) may be switchable between a plurality of states including a first state (e.g., 1030) or a second state (e.g., 1040), based on changing the state of the main display (e.g., 250; 330; 420). The first display condition may include displaying the image on the main display (e.g., 250; 330; 420), and the second display condition may include displaying the image on the sub-display. The instructions may, when executed by the processor (e.g., 120; 440), cause the electronic device (e.g., 101; 200; 300; 400; 1300) to: display the first conversion image (e.g., 940; 1021; 1121; 1221) on the main display (e.g., 250; 330; 420) while the electronic device (e.g., 101; 200; 300; 400; 1300) is in the first state (e.g., 1030); and display the second conversion image (e.g., 950; 1022; 1122; 1222) on the sub-display while the electronic device (e.g., 101; 200; 300; 400; 1300) is in the second state (e.g., 1040).

The first display condition may be that the image displaying time is included in a first time range, and the second display condition may be that the image displaying time is included in a second time range that is different from the first time range. The instructions may, when executed by the processor (e.g., 120; 440), cause the electronic device (e.g., 101; 200; 300; 400; 1300) to: display the first conversion image (e.g., 940; 1021; 1121; 1221), based on a timepoint of display being included in the first time range; and display the second conversion image (e.g., 950; 1022; 1122; 1222), based on the timepoint of display being included in the second time range.

The first display condition may be that the image displaying time is included in the first time range, and the second display condition may be that the image displaying time is included in the second time range that is temporally subsequent to the first time range. The instructions may, when executed by the processor (e.g., 120; 440), cause the electronic device (e.g., 101; 200; 300; 400; 1300) to: display the first conversion image (e.g., 940; 1021; 1121; 1221) based on the timepoint of display being included in the first time range; and based on the timepoint of display being out of the first time range and included in the second time range as time elapses, change the image displayed on the display (e.g., 160; 250; 330; 420) from the first conversion image (e.g., 940; 1021; 1121; 1221) to the second conversion image (e.g., 950; 1022; 1122; 1222).

The electronic device (e.g., 101; 200; 300; 400; 1300) may further include a communication circuit. The first display condition may include displaying the image by the electronic device (e.g., 101; 200; 300; 400; 1300), and the second display condition may include displaying the image by another electronic device. The instructions may, when executed by the processor (e.g., 120; 440), cause the electronic device (e.g., 101; 200; 300; 400; 1300) to: based on acquiring a user input indicating setting the target image (e.g., 830; 930; 1010; 1110; 1210) as a setup image common to the electronic device (e.g., 101; 200; 300; 400; 1300) and the other electronic device, display the first conversion image (e.g., 940; 1021; 1121; 1221) as the setup image of the electronic device (e.g., 101; 200; 300; 400; 1300); and transmit the second conversion image (e.g., 950; 1022; 1122; 1222) to the other electronic device such that the other electronic device displays the second conversion image (e.g., 950; 1022; 1122; 1222) as the setup image of the other electronic device.

The instructions may, when executed by the processor (e.g., 120; 440), cause the electronic device (e.g., 101; 200; 300; 400; 1300) to: display a classification setting interface (e.g., 600-1; 600-2; 700) including an interest object area (e.g., 610) corresponding to the object of interest, a non-interest object area (e.g., 620) corresponding to the object of non-interest, and an unclassified object area (e.g., 630) corresponding to an unclassified object; display, on the classification setting interface (e.g., 600-1; 600-2; 700), a plurality of graphical representations respectively corresponding to the plurality of candidate objects, each with a size based on a frequency of appearance of each of the candidate objects; based on a user input that moves at least one graphical representation of the plurality of graphical representations, change a position of the at least one graphical representation; and classify the candidate objects, based on an area including a position of a graphical representation corresponding to each candidate object, among the interest object area (e.g., 610), the non-interest object area (e.g., 620), and the unclassified object area (e.g., 630).

The instructions may, when executed by the processor (e.g., 120; 440), cause the electronic device (e.g., 101; 200; 300; 400; 1300) to: adjust, based on a distance between a first graphical representation corresponding to a first candidate object among the plurality of candidate objects and a second graphical representation corresponding to a second candidate object among the plurality of candidate objects, a likelihood of selecting, as the target image (e.g., 830; 930; 1010; 1110; 1210), an image including the first candidate object and the second candidate object from among the plurality of images (e.g., 820; 920).

The instructions may, when executed by the processor (e.g., 120; 440), cause the electronic device (e.g., 101; 200; 300; 400; 1300) to: based on a user input that adjusts a size of at least one graphical representation of the plurality of graphical representations respectively corresponding to the plurality of candidate objects, adjust the size of the at least one graphical representation; and adjust, based on the adjusted size, a likelihood of selecting, as the target image (e.g., 830; 930; 1010; 1110; 1210), an image including a candidate object corresponding to the at least one graphical representation.

The instructions may, when executed by the processor (e.g., 120; 440), cause the electronic device (e.g., 101; 200; 300; 400; 1300) to: based on a user input that moves at least one graphical representation of the plurality of graphical representations respectively corresponding to the plurality of candidate objects, change a position of the at least one graphical representation; and determine, based on an overlapping area of the first graphical representation and the second graphical representation of the plurality of graphical representations, that the first candidate object corresponding to the first graphical representation is the same object as the second candidate object corresponding to the second graphical representation.

The instructions may, when executed by the processor (e.g., 120; 440), cause the electronic device (e.g., 101; 200; 300; 400; 1300) to: select, as the target image (e.g., 830; 930; 1010; 1110; 1210), at least one image including at least one of the object of interest of the first classification result (e.g., 901) or the object of interest of the second classification result (e.g., 902), from among the plurality of images (e.g., 820; 920).

According to embodiments, a method performed by an electronic device (e.g., 101; 200; 300; 400; 1300), the method may include: detecting a plurality of candidate objects from a plurality of images (e.g., 820; 920); determining a first classification result (e.g., 901) by classifying at least one of the plurality of candidate objects as an object of interest or an object of non-interest, based on a user input for a first display condition for at least one of an image displaying device that is a device for displaying an image, an image displaying area of a display (e.g., 160; 250; 330; 420) of the image displaying device, or an image displaying time at which the image is displayed; determining a second classification result (e.g., 902) by classifying at least one of the plurality of candidate objects as an object of interest or an object of non-interest, based on a user input for a second display condition; generating, from a target image (e.g., 830; 930; 1010; 1110; 1210), a first conversion image (e.g., 940; 1021; 1121; 1221) corresponding to the first display condition by retaining the object of interest of the first classification result (901) and excluding the object of non-interest of the first classification result (e.g., 901); generating, from the target image (e.g., 830; 930; 1010; 1110; 1210), a second conversion image (e.g., 950; 1022; 1122; 1222) corresponding to the second display condition by retaining the object of interest of the second classification result (e.g., 902) and excluding the object of non-interest of the second classification result (e.g., 902); displaying the first conversion image (940; 1021; 1121; 1221) while the electronic device (e.g., 101; 200; 300; 400; 1300) satisfies the first display condition; and displaying the second conversion image (e.g., 950; 1022; 1122; 1222) while the electronic device (e.g., 101; 200; 300; 400; 1300) satisfies the second display condition. Reference numerals herein for purposes of example only and are not intended to be limiting.

The first display condition may include displaying the image in a first area of the display (160; 250; 330; 420) of the electronic device (101; 200; 300; 400; 1300), and the second display condition may include displaying the image in a second area of the display (160; 250; 330; 420) of the electronic device (101; 200; 300; 400; 1300). The displaying of the first conversion image (940; 1021; 1121; 1221) may include displaying the first conversion image (940; 1021; 1121; 1221) in the first area based on displaying an image generated from the target image (830; 930; 1010; 1110; 1210) in the first area, and the displaying of the second conversion image (950; 1022; 1122; 1222) may include displaying the second conversion image (950; 1022; 1122; 1222) in the second area based on displaying an image generated from the target image (830; 930; 1010; 1110; 1210) in the second area. “Based on” as used herein covers based at least on.

The first display condition may include, of a main display (250; 330; 420) capable of changing a state and a sub-display, which are included in the display (160; 250; 330; 420) of the electronic device (101; 200; 300; 400; 1300), displaying the image on the main display (250; 330; 420) in the first area, and the second display condition may include displaying the image on the sub-display. A state of the electronic device (101; 200; 300; 400; 1300) may be switchable between a plurality of states including a first state (1030) or a second state (1040), based on changing the state of the main display (250; 330; 420). The displaying of the first conversion image (940; 1021; 1121; 1221) may include displaying the first conversion image (940; 1021; 1121; 1221) on the main display (250; 330; 420) while the electronic device (101; 200; 300; 400; 1300) is in the first state (1030), and the displaying of the second conversion image (950; 1022; 1122; 1222) may include displaying the second conversion image (950; 1022; 1122; 1222) on the sub-display while the electronic device (101; 200; 300; 400; 1300) is in the second state (1040).

The first display condition may be that the image displaying time is included in a first time range, and the second display condition may be that the image displaying time is included in a second time range that is different from the first time range. The displaying of the first conversion image (940; 1021; 1121; 1221) may include displaying the first conversion image (940; 1021; 1121; 1221) based on a timepoint of display being included in the first time range, and the displaying of the second conversion image (950; 1022; 1122; 1222) may include displaying the second conversion image (950; 1022; 1122; 1222) based on the timepoint of display being included in the second time range.

The first display condition may be that the image displaying time is included in the first time range, and the second display condition may be that the image displaying time is included in the second time range that is temporally subsequent to the first time range. The displaying of the first conversion image (940; 1021; 1121; 1221) may include displaying the first conversion image (940; 1021; 1121; 1221) based on the timepoint of display being included in the first time range, and the displaying of the second conversion image (950; 1022; 1122; 1222) may include, based on the timepoint of display being out of the first time range and included in the second time range as time elapses, changing the image displayed on the display (160; 250; 330; 420) from the first conversion image (940; 1021; 1121; 1221) to the second conversion image (950; 1022; 1122; 1222).

The first display condition may include displaying the image by the electronic device (101; 200; 300; 400; 1300), and the second display condition may include displaying the image by another electronic device. The displaying of the first conversion image (940; 1021; 1121; 1221) may include, based on acquiring a user input indicating setting the target image (830; 930; 1010; 1110; 1210) as a setup image common to the electronic device (101; 200; 300; 400; 1300) and the other electronic device, displaying the first conversion image (940; 1021; 1121; 1221) as the setup image of the electronic device (101; 200; 300; 400; 1300), and the displaying of the second conversion image (950; 1022; 1122; 1222) may include transmitting the second conversion image (950; 1022; 1122; 1222) to the other electronic device such that the other electronic device displays the second conversion image (950; 1022; 1122; 1222) as the setup image of the other electronic device.

The determining of the first classification result (901) may include displaying a classification setting interface (600-1; 600-2; 700) including an interest object area (610) corresponding to the object of interest, a non-interest object area (620) corresponding to the object of non-interest, and an unclassified object area (630) corresponding to an unclassified object; displaying, on the classification setting interface (600-1; 600-2; 700), a plurality of graphical representations respectively corresponding to the plurality of candidate objects, each with a size based on a frequency of appearance of each of the candidate objects; based on a user input that moves at least one graphical representation of the plurality of graphical representations, changing a position of the at least one graphical representation; and classifying the candidate objects, based on an area including a position of a graphical representation corresponding to each candidate object, among the interest object area (610), the non-interest object area (620), and the unclassified object area (630).

The method may further include: adjusting, based on a distance between a first graphical representation corresponding to a first candidate object among the plurality of candidate objects and a second graphical representation corresponding to a second candidate object among the plurality of candidate objects, a likelihood of selecting, as the target image (830; 930; 1010; 1110; 1210), an image including the first candidate object and the second candidate object from among the plurality of images (820; 920).

According to an embodiment of the present disclosure, an electronic device may be a device of one of various types. The electronic device may include, as non-limiting examples, a portable communication device (e.g., a smartphone, etc.), a computing device, a portable multimedia device, a portable medical device, a camera, a wearable device, a home appliance, or the like. However, the electronic device is not limited to the foregoing examples.

It is to be understood that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. Terms such as “first” and “second,” or “initial” or “subsequent” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., by wire), wirelessly, or via at least a third element(s).

As used in connection with certain embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to various embodiments of the present disclosure, a method described herein may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct and/or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computing systems so that the software is stored and executed in a distributed fashion. The software and data may be stored by one or more non-transitory computer-readable recording mediums.

The methods according to the embodiments described above may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to a person of ordinary skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the embodiments described above, or vice versa.

While the disclosure has been illustrated and described with reference to various embodiments, it will be understood that the various embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a display;
at least one processor comprising processing circuitry; and
a memory configured to store instructions,
wherein the instructions, when executed by the at least one processor individually and/or collectively, are configured to cause the electronic device to:
detect a plurality of candidate objects from a plurality of images;
determine a first classification result by classifying at least one of the plurality of candidate objects as an object of interest or an object of non-interest, based on a user input for a first display condition for at least one of an image displaying device that is a device for displaying an image, an image displaying area of a display of the image displaying device, or an image displaying time at which the image is displayed;
determine a second classification result, by classifying at least one of the plurality of candidate objects as an object of interest or an object of non-interest, based on a user input for a second display condition;
generate, from a target image, a first conversion image corresponding to the first display condition by retaining the object of interest of the first classification result and excluding the object of non-interest of the first classification result;
generate, from the target image, a second conversion image corresponding to the second display condition by retaining the object of interest of the second classification result and excluding the object of non-interest of the second classification result;
display the first conversion image while the electronic device satisfies the first display condition; and
display the second conversion image while the electronic device satisfies the second display condition.

2. The electronic device of claim 1, wherein the display comprises:
a first area and a second area,
wherein the first display condition comprises:
displaying the image in the first area,
the second display condition comprises:
displaying the image in the second area,
wherein the instructions, when executed by the at least one processor, cause the electronic device to:
based on displaying an image generated from the target image in the first area, display the first conversion image in the first area; and
based on displaying an image generated from the target image in the second area, display the second conversion image in the second area.

3. The electronic device of claim 1, wherein the display comprises:
a main display capable of changing a state, and a sub-display,
wherein a state of the electronic device is switchable between a plurality of states comprising a first state and a second state, based on changing the state of the main display,
wherein the first display condition comprises:
displaying the image on the main display, and
the second display condition comprises:
displaying the image on the sub-display,
wherein the instructions, when executed by the at least one processor, cause the electronic device to:
display the first conversion image on the main display while the electronic device is in the first state; and
display the second conversion image on the sub-display while the electronic device is in the second state.

4. The electronic device of claim 1, wherein the first display condition is that the image displaying time is included in a first time range, and
the second display condition is that the image displaying time is included in a second time range that is different from the first time range,
wherein the instructions, when executed by the at least one processor, cause the electronic device to:
display the first conversion image, based on a timepoint of display being included in the first time range; and
display the second conversion image, based on the timepoint of display being included in the second time range.

5. The electronic device of claim 1, wherein the first display condition comprises that the image displaying time is included in the first time range, and
the second display condition comprises that the image displaying time is included in the second time range that is temporally subsequent to the first time range,
wherein the instructions, when executed by the at least one processor, cause the electronic device to:
display the first conversion image based on the timepoint of display being included in the first time range; and
based on the timepoint of display being out of the first time range and included in the second time range as time elapses, change the image displayed on the display from the first conversion image to the second conversion image.

6. The electronic device of claim 1, further comprising:
a communication circuit;
wherein the first display condition comprises:
displaying the image by the electronic device, and
the second display condition comprises:
displaying the image by another electronic device,
wherein the instructions, when executed by the at least one processor, cause the electronic device to:
based on acquiring a user input indicating setting the target image as a setup image common to the electronic device and the other electronic device, display the first conversion image as the setup image of the electronic device; and
transmit the second conversion image to the other electronic device so that the other electronic device can display the second conversion image as the setup image of the other electronic device.

7. The electronic device of claim 1, wherein the instructions, when executed by the at least one processor, cause the electronic device to:
display a classification setting interface comprising an interest object area corresponding to the object of interest, a non-interest object area corresponding to the object of non-interest, and an unclassified object area corresponding to an unclassified object;
display, on the classification setting interface, a plurality of graphical representations respectively corresponding to the plurality of candidate objects, each with a size based on a frequency of appearance of each of the candidate objects;
based on a user input that moves at least one graphical representation of the plurality of graphical representations, change a position of the at least one graphical representation; and
classify the candidate objects, based on an area including a position of a graphical representation corresponding to each candidate object, among the interest object area, the non-interest object area, and the unclassified object area.

8. The electronic device of claim 1, wherein the instructions, when executed by the at least one processor, cause the electronic device to:
adjust, based on a distance between a first graphical representation corresponding to a first candidate object among the plurality of candidate objects and a second graphical representation corresponding to a second candidate object among the plurality of candidate objects, a likelihood of selecting, as the target image, an image including the first candidate object and the second candidate object from among the plurality of images.

9. The electronic device of claim 1, wherein the instructions, when executed by the at least one processor, cause the electronic device to:
based on a user input to adjust a size of at least one graphical representation of the plurality of graphical representations respectively corresponding to the plurality of candidate objects, adjust the size of the at least one graphical representation; and
adjust, based on the adjusted size, a likelihood of selecting, as the target image, an image including a candidate object corresponding to the at least one graphical representation.

10. The electronic device of claim 1, wherein the instructions, when executed by the at least one processor, cause the electronic device to:
based on a user input that moves at least one graphical representation of the plurality of graphical representations respectively corresponding to the plurality of candidate objects, change a position of the at least one graphical representation; and
determine, based on an overlapping area of the first graphical representation and the second graphical representation of the plurality of graphical representations, that the first candidate object corresponding to the first graphical representation is the same object as the second candidate object corresponding to the second graphical representation.

11. The electronic device of claim 1, wherein the instructions, when executed by the at least one processor, cause the electronic device to:
select, as the target image, at least one image including at least one of the object of interest of the first classification result or the object of interest of the second classification result, from among the plurality of images.

12. A method performed by an electronic device, the method comprising:
detecting a plurality of candidate objects from a plurality of images;
determining a first classification result by classifying at least one of the plurality of candidate objects as an object of interest or an object of non-interest, based on a user input for a first display condition for at least one of: an image displaying device that is a device for displaying an image, an image displaying area of a display of the image displaying device, or an image displaying time at which the image is displayed;
determining a second classification result by classifying at least one of the plurality of candidate objects as an object of interest or an object of non-interest, based on a user input for a second display condition;
generating, from a target image, a first conversion image corresponding to the first display condition by retaining the object of interest of the first classification result and excluding the object of non-interest of the first classification result;
generating, from the target image, a second conversion image corresponding to the second display condition by retaining the object of interest of the second classification result and excluding the object of non-interest of the second classification result;
displaying the first conversion image while the electronic device satisfies the first display condition; and
displaying the second conversion image while the electronic device satisfies the second display condition.

13. The method of claim 12, wherein the first display condition comprises:
displaying the image in a first area of the display of the electronic device,
the second display condition comprises:
displaying the image in a second area of the display of the electronic device,
wherein the displaying of the first conversion image comprises:
based on displaying an image generated from the target image in the first area, displaying the first conversion image in the first area, and
the displaying of the second conversion image comprises:
based on displaying an image generated from the target image in the second area, displaying the second conversion image in the second area.

14. The method of claim 12, wherein the first display condition comprises:
of a main display capable of changing a state and a sub-display, which are comprised in the display of the electronic device, displaying the image on the main display in the first area, and
the second display condition comprises:
displaying the image on the sub-display,
wherein a state of the electronic device is switchable between a plurality of states comprising a first state or a second state, based on changing the state of the main display,
wherein the displaying of the first conversion image comprises:
displaying the first conversion image on the main display while the electronic device is in the first state, and
the displaying of the second conversion image comprises:
displaying the second conversion image on the sub-display while the electronic device is in the second state.

15. The method of claim 12, wherein the first display condition comprises that the image displaying time is included in a first time range, and
the second display condition comprises that the image displaying time is included in a second time range that is different from the first time range,
wherein the displaying of the first conversion image comprises:
displaying the first conversion image, based on a timepoint of display being included in the first time range, and
the displaying of the second conversion image comprises:
displaying the second conversion image, based on the timepoint of display being included in the second time range.

16. The method of claim 12, wherein the first display condition comprises that the image displaying time is included in the first time range, and
the second display condition comprises that the image displaying time is included in the second time range that is temporally subsequent to the first time range,
wherein the displaying of the first conversion image comprises:
displaying the first conversion image based on the timepoint of display being included in the first time range, and
the displaying of the second conversion image comprises:
based on the timepoint of display being out of the first time range and included in the second time range as time elapses, changing the image displayed on the display from the first conversion image to the second conversion image.

17. The method of claim 12, wherein the first display condition comprises:
displaying the image by the electronic device, and
the second display condition comprises:
displaying the image by another electronic device,
wherein the displaying of the first conversion image comprises:
based on acquiring a user input indicating setting the target image as a setup image common to the electronic device and the other electronic device, displaying the first conversion image as the setup image of the electronic device, and
the displaying of the second conversion image comprises:
transmitting the second conversion image to the other electronic device such that the other electronic device can display the second conversion image as the setup image of the other electronic device.

18. The method of claim 12, wherein the determining of the first classification result comprises:
displaying a classification setting interface comprising an interest object area corresponding to the object of interest, a non-interest object area corresponding to the object of non-interest, and an unclassified object area corresponding to an unclassified object;
displaying, on the classification setting interface, a plurality of graphical representations respectively corresponding to the plurality of candidate objects, each with a size based on a frequency of appearance of each of the candidate objects;
based on a user input that moves at least one graphical representation of the plurality of graphical representations, changing a position of the at least one graphical representation; and
classifying the candidate objects, based on an area including a position of a graphical representation corresponding to each candidate object, among the interest object area, the non-interest object area, and the unclassified object area.

19. The method of claim 12, further comprising:
adjusting, based on a distance between a first graphical representation corresponding to a first candidate object among the plurality of candidate objects and a second graphical representation corresponding to a second candidate object among the plurality of candidate objects, a likelihood of selecting, as the target image, an image including the first candidate object and the second candidate object from among the plurality of images.

20. A non-transitory computer-readable storage medium storing one or more computer programs comprising instructions to perform the method of claim 12.
